(19) United States
(12) Patent Application Publication
(10) Pub. No.: US 2007/0122573 A1
(43) Pub. Date: May 31, 2007

(54) ATMOSPHERE IMPROVING TAPE FOR PACKAGE, PACKAGE WITH ATMOSPHERE IMPROVING TAPE AND METHOD OF MANUFACTURING THE PACKAGE, PACKAGE CONTAINER WITH ATMOSPHERE IMPROVING TAPE, ENGAGING DEVICE , AND PACKAGE WITH ENGAGING DEVICE

(75) Inventors: Tetsurou Yasuike, Tokyo (JP); Masato Doi, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IDEMITSU UNITECH CO., LTD., Tokyo (JP)

(21) Appl. No.: 11/608,628

(22) Filed: Dec. 8, 2006

Related U.S. Application Data
(62) Division of application No. 10/494,323, filed on Apr. 30, 2004.

(30) Foreign Application Priority Data
Nov. 1, 2001 (JP) 2001-336865
Nov. 1, 2001 (JP) 2001-336866
Jan. 24, 2002 (JP) 2002-15764
May 17, 2002 (JP) 2002-142943

(51) Int. Cl. E06B 3/00

(52) U.S. Cl. 428/34

(57) ABSTRACT

The atmosphere improving tape 10 for a package comprising a rectangular atmosphere improving layer 10A in the inner side and a thermoplastic resin layer 10B surrounding the atmosphere improving layer in the outer side. The atmosphere improving layer 10A contains an atmosphere improving material such as an deoxidizing agent. With the present invention, miss use and injection miss of an atmosphere improving material never occur, and a packaging material can freely be selected with no load to the environment. The tape is excellent in the formability, and the atmosphere improving capability can easily be given to the tape.

### TECHNICAL FIELD

The present invention relates to an atmosphere improving tape for a package, a package with the atmosphere improving tape and a method of manufacturing the same, a packaging container with the atmosphere improving tape, an engaging device (a zipper), and a package with the engaging device (the zipper).

### BACKGROUND ART

In the conventional technology, a deoxidizer is sealed in a package to prevent oxidation of foods or drugs therein, and a drying agent is sealed in a package to prevent degradation of foods and drugs caused by absorption of moisture. An insect repellent is sealed in a package to prevent damages of clothing packaged therein by insects, and a preservative against mold is sealed therein to prevent mold. Further an antirust is sealed in a package to prevent generation of rust on metallic portions of industrial parts packaged therein.

As described above, various types of atmosphere improving materials are used for preserving atmosphere in various types of packages.

These atmosphere improving materials are generally sealed in a small bag in use.

When a small bag with the atmosphere improving material packed therein is put in a package in which a product is packaged, however, unless the small bag is fixed within the package, the bag may be mixed in the product to generate the sense of discomfort.

As a film for forming a package, there have been proposed a multi-layered oxygen-absorbing film comprising an oxygen-absorbing layer with a deoxidizer mixed therein and a layer comprising a thermoplastic resin (Japanese Patent Laid-Open Publication No. SHO 63-137838), a multi-layered damp-proof film comprising a drying agent layer with a drying agent mixed therein and a layer comprising other thermoplastic resin (Japanese Patent Laid-Open Publication No. HEI 5-39379), or the like.

In the conventional technology as described above, the atmosphere improving layer such as the oxygen-absorbing layer or the drying agent layer is based on the configuration in which a deoxidizer or a drying agent is kneaded in a respective prespecified thermoplastic resin. Further as a film for forming a package, sometimes there has also been used a film prepared by extrusion molding a thermoplastic resin having the atmosphere improving characteristics such as the deoxidizing capability.

When the film having the atmosphere improving characteristics as described above is processed, however, there occurs the disadvantageous problem that, for instance, it is difficult to adjust the fluidity of the resin for forming a film with large dimensions and there are many restrictions in selecting the atmosphere improving material.

Also when the atmosphere improving film with a required material kneaded therein is processed, a resin for forming the atmosphere improving layer is simultaneously injection-molded together with other resin, so that sometimes an adhesion layer containing an adhesive enabling adhesion of the resin to the other one may be required. Therefore, when also a combination of the adhesive and the atmosphere improving material is taken into consideration, restrictions in selection of the atmosphere improving material disadvantageously increase.

In addition, in the package using the film as described above, sometimes the atmosphere improving layer is exposed to outside of the package in a cross-sectional portion at an edge of the film. Because of the configuration, when this package is boiled or heated, the atmosphere improving material in the atmosphere improving layer may be eluded from the cross-sectional portion at the film edge to cause contamination around the package.

One of the objects of the present invention is to allow many employable atmosphere improving materials and to eliminate contaminations around a package caused by the atmosphere improving material.

On the other hand, in a case where the atmosphere improving material is put in a small bag in use, the material is put in each bag discretely, which is troublesome, and further there is the possibility that injection miss into a small bag may occur.

To eliminate the problems as described above, there has been proposed an antirust sheet formed by mixing a volatile antirust in unwoven cloth which can be used as a packaging bag to accommodate parts or the like therein (Japanese Patent Laid-Open Publication No. HEI 5-65168).

Although the sheets as described above can solve the problems such as miss injection into a small bag and reduce the work load, atmosphere improvement is realized by coating a sheet forming a packaging bag with a chemical agent, so that it is required to select a sheet material adapted to be coated with the chemical agent. Because of this requirement, there are some restrictions in selection of a packaging material, which may disadvantageously sacrifice the function of the packaging material such as the strength and transparency. Further as a chemical agent is included in loss during the manufacturing process, there may occur such a problem as excessive load to environment such as environmental contamination.

Another object of the present invention is to prevent miss use and miss injection of atmosphere improving materials, allow free selection of a packaging material, and reduce load to the environment.

The multilayered sheet comprising the oxygen-absorbing layer or the like as described above is not adapted to be molded, and it is often difficult to manufacture a container with the oxygen-absorbing capability.

A still further object of the present invention is to provide the excellent moldability as well as the excellent capability for improving atmosphere.

As another configuration for providing the capability for improving atmosphere, there has been proposed a label based on the sheet configuration comprising a separator layer, an adhesion layer, a deoxidizing layer, and a perforated layer. When this label is used, the separator is pealed off, and the label is adhered to an internal surface of a bag having the oxygen gas barrier capability from the adhesion layer (Japanese Patent Laid-Open Publication No. HEI 7-219430).

With the technology as described above, however, as an adhesive is used for adhering the label to a bag, sometimes odor of the adhesive may disadvantageously be generated and transferred to the contents.

A still further different object of the present invention is to easily provide the oxygen absorbing capability and prevent the odor from being transferred to the contents.

### DISCLOSURE OF THE INVENTION

The atmosphere improving tape for a package according to the present invention is characterized in that the tape comprises an atmosphere improving layer containing an atmosphere improving material therein, and a thermoplastic layer not containing an atmosphere improving material therein, and also in that the atmosphere improving layer has a cross section coated with the thermoplastic resin layer.

With the present invention as described above, because of the tape-like form, the tape can easily be fixed to package such as a packaging bag, it is not mixed in or mistook for a product packaged therein, so that miss use of the atmosphere improving material never occurs.

Further, a separate body such as a small bag is not required to be used, and the tape can be fixed to a package during the process of manufacturing the package, so that miss injection of the atmosphere improving material never occurs.

In addition, addition of an atmosphere improving material into a packaging material is not required, and the atmosphere improving tape for a package can discretely be fixed to a packaging material such as a sheet in use, and as it is not necessary to take into considerations a combination of an atmosphere improving material and a packaging material, a packaging material for a package such as a packaging bag can freely be selected.

The atmosphere improving is contained in the tape portion, so that loss during the process of manufacturing the packaging material can be reduced, and therefore excessive load to the environment never occurs.

Further the atmosphere improving layer has a cross section coated with the thermoplastic resin layer, so that the atmosphere improving material never leaks from the atmosphere improving tape for a package, and therefore a product or the like in the package is never contaminated.

An atmosphere improving tape for a package according to the present invention comprises an atmosphere improving layer containing an atmosphere improving material therein, and a thermoplastic resin layer not containing an atmosphere improving material, and is characterized in that the atmosphere improving layer has a cross section with the thermoplastic resin layer laminated thereon.

Any form of a cross section of the atmosphere improving tape for a package is allowable on the condition that the atmosphere improving layer has a cross section with the thermoplastic resin layer laminated thereon, and the employable forms include a form in which the atmosphere improving layer is exposed only in one direction, a form in which the atmosphere improving layer is laminated with two thermoplastic layers, and a form in which the thermoplastic resin layer is laminated on the atmosphere improving layer.

With the present invention as described above, the actions and effects similar to those described above can be obtained.

In the atmosphere improving tape for a package according to the present invention, it is desirable that the atmosphere improving layer is made from a kneaded material comprising an atmosphere improving material and a thermoplastic body.

With the features described above, when the atmosphere improving layer is made from a kneaded material comprising an atmosphere improving material and a thermoplastic body, the absorption rate is lower than that of powder, but the water-proof characteristics of the resin is improved, so that it is well suited to packaging of water-containing pouch-packed foods such as gruel.

In the atmosphere improving tape for a package according to the present invention, the atmosphere improving material preferably contains at least any one of a water absorbing material, a drying agent, a volatile antibiotic agent, a volatile preservative against mold, a volatile antitick agent, a volatile insect repellent, a deodorant, a volatile antirust agent, a volatile animal repelling agent, a deoxidizing agent, and an absorbing agent.

Because of the feature, an atmosphere improving material may be employed according to an application, so that the atmosphere improving tape for a package can be used for various applications.

The atmosphere improving materials available for this purpose include an oxygen absorbing agent (a deoxidizing agent), an absorbing agent, a deodorant, a water absorbing material, a drying agent, a volatile antibiotic agent, a preservative against mold, a volatile antitick agent, a volatile insect repellent, a volatile antirust agent, and a volatile animal repelling agent.

The oxygen absorbing agents available for this purpose include, for instance, metallic powder of such metals as iron and zinc, oxides with low reducing capability of iron such as FeO, FeTiO₂, and Fe₂O₃, organic metal complexes, compound of transitional metals, ascorbic acid, phenol-based substances, sulfite salt, hydrogen sulfite, tiosulfate salt, oxalates, pyrogallol, catechol, longalit, vitamin C, nanocomposite nylon resin, polyester with butane diol branched in the molecule, glucose, and oxygen absorbing polymers such as oxygen absorbing polymer.

The absorbents available for this purpose include calcium oxide, an alumina drying agent, silica gel, magnesium salt, and zeolite.

The deodorants available for this purpose include silica gel, active alumina, titanium oxide, zinc oxide, carbon black, and zeolite.

The water absorbing materials available for this purpose include, polyacrylate, vinyl acetate-acrylate copolymer, degenerative bridged polyvinyl alcohol, ultra-fine water-absorbing acrylic textile, and thermoplastic polyethylene oxide.

The drying agents available for this purpose include calcium oxide, an alumina drying agent, silica gel, magnesium salt, and zeolite.

The volatile antibiotic agents available for this purpose include isocyanic acid compounds, Japanese cypress thiol, oil extracted from bamboo, oil extracted from beefsteak plant, and thiazolyl sulfamide compounds.

The drying agents available for this purpose include calcium oxide, an alumina drying agent, silica gel, magnesium salt, and zeolite.

The volatile preservatives against mold available for this purpose include organic tin compounds, organic sulfur compounds, chlorine-based compounds, phenol-based compounds, and thymol.

The volatile antitick agents available for this purpose include allethrin, tetramethrin, lesmethrin, phenotoframethrin, permethrin, diphenothrin, tralomethrin, empenthrin, DDVP, fenithion, temephos, diflubenzron, buprofedin, pyriproxiphen, and mentha oil.

The volatile insect repellants available for this purpose include cresol, O-phenyl phenol, parathion, and imidazole.

The volatile antirust agents available for this purpose include biannulate benzoazole compounds, monoannulate imidazole, triazole, rosin, diisopropyl nitrite ammonium, benzoic acid, cabrylic acid, dicyclohexil nitrite ammonium, dicyclo carbonate ammonium, and nitrite.

The volatile animal-repelling agents available for this purpose include pyrethrin, rotenone, phthalthrin, allethrin, permetrin, cybermethrin, alpha cybermethrin, phenothrin, diphenothrin, menthol, Japanese cypress oil, Japanese cedar oil, Hiba oil, dithiocarbamoryl sulfide compounds, cynnamic aldehide, and linalool oil.

As for a form of the atmosphere improving material, in a case where the atmosphere improving material is kneaded in a thermoplastic resin, in a case where the thermoplastic resin is unwoven cloth and the atmosphere improving material is mixed in the thermoplastic resin layer, in a case where the atmosphere improving material is present in a form of fiber or particles, and in a case where the atmosphere improving is infiltrated in fiber, various forms such as the atmosphere improving material blended with thermoplastic resin powder may be employed.

As a thermoplastic resin made from the thermoplastic resin layer, for instance, a layer made from a polyolefin-based resin such as PP (polypropylene) and PE (polyethylene) or from PS (polystyrene) can be enlisted. LLDPE or LDPE can be enlisted as PE, and CPP or the like as PP. Further the atmosphere improving material made from a raw material which can easily be adhered thermally to or can easily be separated may be added to the polyolefin-based rein or PS. As the additive, for instance, such materials as EVA (ethylene vinyl acetate), SBS (styrene-butadiene-styrene) rubber or EPR (ethylene-propylene rubber) kneaded in the polyolefin resin, and a mixture of PP and PE can be enlisted.

As the thermoplastic resin used for forming the thermoplastic resin, also polyethylene telephthalate or nylon may be used.

As a form of the thermoplastic resin layer, various forms including a resin form, a sheet-like form, an unwoven cloth form, and synthetic paper may be employed.

As a method of manufacturing the atmosphere improving tape for a package, various methods may be employed including the multilayer co-extrusion method, multilayer different form extrusion method, a method in which an atmosphere improving material is filled in a thermoplastic resin tube and then is thermally applied with a heating roller or the like, and a method in which an atmosphere improving material is filled in a section between fibers of unwoven or woven clothes each made from a thermoplastic resin and coated with a thermoplastic resin sheet or the like, and is thermally applied thereto, or a method in which the atmosphere improving material is inserted into a thermoplastic resin tube.

In addition, a method may be employed in which a resin extruded as a single layer in the tape-like form for forming an atmosphere improving layer, or that processed into a sheet-like form and then slit into a tape-like form is held between two sheets to form a thermoplastic resin layer and the two sheets are thermally adhered to each other to form an atmosphere improving tape.

There is no specific restriction over a form of the atmosphere improving tape for a package, but the form is generally like a lengthy rectangle. Any form of the cross section is allowable on the condition that the atmosphere improving layer has a cross section coated with the thermoplastic resin layer, and any configuration may be employed including that in which the atmosphere improving layer having a rectangular form is completely covered with a thermoplastic resin layer, or that in which a periphery of a circular atmosphere improving layer is covered with a thermoplastic resin layer having a doughnut-like form.

The completed atmosphere improving tape for a package may be, for instance, wound around a drum like an electric cable, or discretely be put in a cardboard box.

There is no specific restriction over a form of the atmosphere improving tape, and generally the atmosphere improving tape has a lengthy rectangular form. Any form of the cross section is allowable on the condition that the atmosphere improving layer has a cross section covered with the thermoplastic resin layer, and any configuration may be employed including that in which the atmosphere improving layer having a rectangular form is completely covered with a thermoplastic resin layer, or that in which a periphery of a circular atmosphere improving layer is covered with a thermoplastic resin layer having a doughnut-like form.

Further there is no restriction over a form of an edge section of the atmosphere improving tape, and any configuration is allowable including that in which an edge section of the tape has a straight form, that in which an edge of the tape has a semi-circular form, and that in which at least the atmosphere improving layer portion in the edge section of the tape is notched with a semi-circular form.

As a method of manufacturing the atmosphere improving tape for a package, there is, for instance, the method in which a lengthy belt-formed sheet with the atmosphere improving tape thermally adhered thereto and a sheet without the atmosphere improving tape thermally adhered thereto are overlaid on each other so that the atmosphere improving tape will be in the inner side of the sheet and are thermally adhered to each other to form the overlaid sheets into a bag. As a method of applying the tape, there can be enlisted, for instance, the method in which the sheet having a form like that of a lengthy belt is fed out with the atmosphere improving tape fed out concurrently and the sheet and tape are thermally adhered to each other.

The package with the atmosphere improving tape according to the present invention is formed by sealing a peripheral edge of the sheet to protect the contents from exposure to air, and is characterized in that the atmosphere improving tape for a package described above is thermally adhered in a continuous form to an internal surface of the sheet when the package with the atmosphere improving tape is formed.

With the present invention as described above, as the atmosphere improving tape for a package described above is thermally adhered in a continuous form to an internal surface of the sheet when the package with the atmosphere improving tape is formed, different from the case where a sheet having the atmosphere improving layer itself is manufactured as a package, the atmosphere improving tape for a package is only thermally adhered to inside of the package, so that the manufacturing process is very simple and the production cost is low, and further the capability of improving atmosphere can easily be given to the package.

Further as the atmosphere improving tape for a packaging tape is thermally adhered to the sheet, different from the case in which the tape is adhered to the sheet with adhesive or the like, odor is not generated, and further the heat resistance is provided, so that the tape may be applied for packaging foods to be boiled or pouch-packed foods.

Herein, it is desirable that a sheet can freely be selected according to a type of the atmosphere improving material and also that the sheet has the gas blocking capability. Various types of sheets including, for instance, a sheet made from at least any of polyethylene, polypropylene, aluminum, nylon, ethylene-vinyl alcohol, or a sheet prepared by vapor-depositing an inorganic material such as silicon oxide or aluminum oxide on polyethylene telephtalate as a carrier may be employed.

As the configuration of the sheet, there can be enlisted a monolayer product of high density polyethylene, a monolayer product of polypropylene, polyethylene telephthalate/cast polypropylene, polyethylene telephthalate/aluminum/nylon/linear low density polyethylene, polyethylene telephthalate/ethylene-vinyl alcohol copolymer/nylon/polyolefin-based resin, a layer prepared by having an inorganic material such as silicon oxide or aluminum oxide deposited on polyethylene telephthalate/polyolefin-based resin, polypropylene/ethylene-vinyl alcohol copolymer/polypropylene, and nylon/linear low density polyethylene, and as the polyolefin-based resin, there can be enlisted, for instance, polyethylene or polypropylene.

The term of “sheet” as used herein indicates a film with the relatively small thickness or that made into a container by means of hot shaping.

Forms of the package prepared as described above include a portrait type pillow bag, a landscape type pillow bag, a bag sealed along four edges, a bag sealed along three edges, a gazette bag, a self-sustaining bag, a folded box, and the like.

The method of manufacturing the atmosphere improving tape for package according to the present invention is characterized in that a lengthy sheet is fed out, and an atmosphere improving tape comprising an atmosphere improving layer containing an atmosphere improving material and a thermoplastic resin layer not containing any atmosphere improving material is thermally and continuously adhered from one edge section of the sheet with the thermoplastic resin layer faced in the direction contrary to that of the surface contacting the sheet.

With the present invention as described above, as there is the tape adhering step, it is required only to continuously adhere an oxygen-absorbing tape onto the sheet, so that the atmosphere improving tape can easily be manufactured, and a production rate of packaging bodies each having an oxygen absorbing tape adhered inside thereof and having the oxygen absorbing capability can be raised.

The method of manufacturing the package having the oxygen absorbing tape according to the present invention preferably comprises the tape adhering step as described above; a sheet adhering step in which another sheet is overlaid on the oxygen absorbing tape and the sheets are applied to each other with the oxygen absorbing tape provided therebetween in a partitioning section formed with a prespecified space in which the overlaid structure is partitioned in a direction perpendicular to the longitudinal direction; and a sheet cutting step in which the sheets adhered to each other in the sheet adhering step described above is cut along the partitioned section.

With the configuration as described above, as there is the sheet adhering step and the oxygen absorbing tape is adhered to the sheets on both the top and rear surfaces thereof, and therefore the oxygen absorbing tape can be fixed to the package with the oxygen absorbing tape without fail.

Further as there is the sheet cutting step, the sheets are cut along the partitioning section, so that the positional displacement of a peripheral portion of the package never occurs.

The packaging container with the atmosphere improving tape according to the present invention is one comprising a molded container having a multilayered sheet with a peelable surface layer formed along the open edge thereof, and a covering member thermally adhered to the peripheral edge of the molded container, and the covering member has the atmosphere improving tape described above thermally adhered to the internal surface thereof, and is adhered to the molded container with the atmosphere improving tape for a package therebetween, and because of the configuration, when the covering member is peeled off, also the surface layer is peeled off together.

With the present invention as described above, as the covering member has the atmosphere improving tape for a package thermally adhered thereto, different from the case where a sheet having the atmosphere improving layer is formed as a sheet, the covering member is a body completely separated from the atmosphere improving tape for a package, and therefore the atmosphere improving capability can easily be given to the packaging container,

Further as the covering member is adhered to the molded container with the atmosphere improving tape for a package held therebetween, and when the covering member is peeled off, it is peeled together with the surface layer, and because of the configuration, the covering member can be peeled off from the molded container without exposing the atmosphere improving layer, and therefore leakage of the atmosphere improving material never occurs.

In the package with the atmosphere improving tape and the packaging container according to the present invention, it is preferable that the atmosphere improving tape is thermally adhered to and crosses the edge sections of the sheets facing to each other.

With the configuration, the atmosphere improving tape is thermally adhered to the edge sections of the sheets facing to each other so that it crosses the edge sections, and mal-distribution of the atmosphere improving tape never occurs, so that the atmosphere improving tape can homogeneously be exposed to atmosphere.

In the package with the atmosphere improving tape and the packaging container according to the present invention, the thermoplastic resin layer is preferably formed so that the cross section thereof covers an edge face of the atmosphere improving layer.

With the configuration as described above, the thermoplastic resin layer is formed so that the cross section thereof covers an edge face of the atmosphere improving layer, and therefore contact between the contents and the atmosphere improving material can be prevented without fail.

The zipper according to the present invention comprises a male member and a female member, and the male member and the female member have a belt-formed base section and an engagement section having an engaging function respectively, and are characterized in that an atmosphere improving layer containing an atmosphere improving material therein is provided in the belt-formed base section and/or in the engagement section.

With the configuration, as an atmosphere improving layer containing an atmosphere improving material therein is provided in the belt-formed base section and/or in the engagement section, the package can be opened or closed repeatedly while improving atmosphere within the package, so that the package is well suited to applications in which the package is used several times.

Further it is not necessary to adhere the atmosphere improving tape for a package discretely, and it is required only to adhere the zipper, so that the manufacture is very easy.

In the zipper according to the present invention, the atmosphere improving layer is preferably prepared by kneading the atmosphere improving material in a thermoplastic resin.

With the configuration, when the atmosphere improving layer is prepared by kneading the atmosphere improving material in a thermoplastic resin, although the absorption rate is lower as compared to that in a case of powder, the water-proof characteristics is improved, so that the atmosphere improving tape for a package is well suited to applications for packaging water-containing pouch-packed foods such as gruel.

In the zipper according to the present invention, the atmosphere improving material contains at least any one of a water absorbing material, a drying agent, a volatile antibiotic agent, a volatile preservative against mold, a volatile antitick agent, a volatile insect repellent, a deodorizer, a volatile antirust agent, a volatile animal-repelling agent, a deoxidizing agent, and an absorbent.

With this configuration, the atmosphere improving material can freely be selected according to various applications, and therefore the zipper can be applied to various applications.

The term of belt-formed base section as used herein indicates a portion having a plate-like form.

An engagement section is formed on the same plain as that of the belt-formed base section. In the engagement section, a form of the male member is different from that of the female section, and in a case of the male member, a form of the cross section is, for instance, of a heart shape, and a form of the female section's cross section is, for instance, of a shape like and arc. The engagement section of the male section and that of the female section engage each other.

The male member and female member form a pair to function as the engagement member according to the present invention. This zipper is manufactured by means of extrusion molding with a die. Polyolefin may be used as material of this engagement section, and for instance, LLDPE (linear low density polyethylene), LDPE (low density polyethylene), and PP (polypropylene) may be used for this purpose.

The package with a zipper according to the present invention is prepared by melting a peripheral edge of a sheet for blocking exposure of the contents to air, and is characterized in that the engagement section according to the present invention described above is thermally adhered to the internal surface of the sheet.

With the present invention described above, the actions and effects similar to those described in relation to the zipper can be obtained.

As a packaging bag with the zipper as described above, either one of a monolayer structure comprising only a base layer or a two-layer structure comprising a base layer and a sealant layer comprising the base layer and the engagement member fused to each other formed into a bag-like form may be employed.

As a material for the base member, such materials as PET (polyethylene telephtalate), NY (nylon), and CPP (cast polypropylene) may be employed.

As a material for the sealant layer, polyolefin is preferable because the same material as that for the engagement section can easily be fused thermally thereto, and for instance, such materials as LLDPE (linear low density polyethylene), LDPE (low density polyethylene) and PP (polypropylene) may be employed.

As the method of manufacturing the sheet to be processed into a packaging bag, any of known methods such as the casting method, inflation method, and calendar method may be employed.

When a two-layered sheet is manufactured, as described above, after a sheet functioning as a base layer is molded, the sealant layer is laminated over the base layer by means of any known method such as extrusion laminating, and dry laminating.

The zipper comprising a sheet based on a monolayer structure or a sheet based on a two-layer structure is thermally fused by means of such as the heat sealing method. More specifically, the zipper is fused to two rectangular sheets by means of heat sealing so that the zipper is positioned inside the packaging bag formed as described above. In this step, the zipper is fused at a position close to one edge of the sheet, and by fusing other three edges by means of heat sealing, the two rectangular sheets are formed into a bag.

The package with the atmosphere improving tape according to the present invention is formed by thermally adhering peripheral edge sections of sheets overlaid on each other, and comprises a main body of the package for blocking exposure of the contents to air and an atmosphere improving tape for improving the atmosphere inside the main body of the package, and the atmosphere improving tape is characterized in that it comprises an atmosphere improving layer containing an atmosphere improving material therein and a thermoplastic resin layer thermally adhered to the internal surface of the sheets, and also in that the thermoplastic resin layer has a cross section covering the atmosphere improving layer and an edge section of the atmosphere improving tape in its extending direction is buried in the thermally adhered section of the sheets.

With the present invention as described above, the atmosphere improving tape capable of improving atmosphere inside the main body of the package is thermally adhered to inside of the main body of the package with the atmosphere improving capability given to the tape having the narrow width, and therefore, the difficulty of maintaining the fluidity of a resin used for forming a film with large dimensions as experienced in the conventional technology never occurs. For the reasons as described above, there are few restrictions over selection of an atmosphere improving material, and the atmosphere improving material can be selected from many and various types of candidate materials.

Further as this thermoplastic resin layer has a cross section covering the atmosphere improving layer, an adhesive for adhering the atmosphere improving layer to the thermoplastic resin layer is not required. Therefore, there is no need for taking into considerations a combination of the adhesive with the atmosphere improving material, so that there is no restriction in selection of the atmosphere improving material.

Further as the edge section of the atmosphere improving tape in its extending section is buried in the thermally adhered section of the sheets, so that the atmosphere improving layer is never exposed to outside of the package. Therefore, the atmosphere improving material is never leaked from the atmosphere improving layer, so that contamination around the package never occurs.

In the package with the atmosphere improving tape according to the present invention, a notched section notching larger in the central portion as compared to that in the edge portions in the lateral direction is preferably formed in the extending direction of the atmosphere improving tape.

With this configuration, the thermally adhered portion of the sheets overlaid on each other at a position corresponding to the notched section are wound around in the direction of the thickness of the rape at an edge section of the atmosphere improving tape in its extending direction and are thermally adhered to each other. Therefore, the edge section of the atmosphere improving tape in its extending section are shielded, so that a quantity of the atmosphere improving material leaked from the atmosphere improving layer can be reduced more.

Further, as an area of the thermally adhered sections of the sheets becomes larger as compared to that in the conventional technology, the adhesion strength in the thermally adhered section can be improved, which insured prevention of leakage of the contents without fail.

In the package with the atmosphere improving tape according to the present invention, the notched section preferably has a semi-circular form.

With this configuration, the edge section of the tape in the extending direction is notched more at positions closer to a central portion of the tape in the sideward direction. The atmosphere improving layer is formed at a substantially central position of the tape in the sideward direction. Herein a range from the edge section of the tape in the extending direction to the atmosphere improving layer is made larger, so that a quantity of the atmosphere improving material from the atmosphere improving layer can be reduced.

In the package with the atmosphere improving tape according to the present invention, the atmosphere improving tape preferably has the adhesion strength between the atmosphere improving layer and the thermoplastic resin layer of 500 g/15 mm width or more.

When the adhesion strength between the atmosphere improving layer and the thermoplastic resin layer is less than 500 g/15 mm width, separation of the atmosphere improving layer from the thermoplastic resin layer easily occurs.

The method of manufacturing the package with the atmosphere improving tape according to the present invention is one for manufacturing a package with an atmosphere improving tape comprising a main body of the package for blocking exposure of the contents to air and an atmosphere improving tape thermally adhered to inside of the main body of the package for improving atmosphere inside the package, and the method comprises a notch forming step of forming notched holes with a prespecified space therebetween on the atmosphere improving tape; a tape adhering step of thermally adhering the atmosphere improving tape with the notched holes formed thereon to either one of the overlaid sheets; a sheet adhering step of thermally adhering the sheets overlaid on each other; and a sheet cutting step of cutting the thermally adhered sections of the sheets at positions for dividing each notched hole.

With the present invention as described above, the thermally adhered section of the sheets are divided at positions corresponding to the notched holes, so that there is a space between an edge face of the cut sheet and an edge face of each notched holes on the atmosphere improving tape. Namely the edge section of the atmosphere improving section is buried in the thermally adhered section of the sheets, so that the atmosphere improving layer is never exposed to outside of the package. Because of the configuration, leakage of the atmosphere improving material from the atmosphere improving layer never occurs, so that a package not causing contamination around it can be manufactured.

The sheet as used herein includes a laminated sheet comprising a plurality of sheets laminated on each other, and a monolayer sheet made from a single material.

Any type of laminated sheet may be used on the conditions that the sheet comprises a base material and a sealant. The sealant means a sheet functioning for adhesion between the sheets when a package is manufactured.

For instance, in a case of a combination of PET (polyethylene telephthalate) as a base material and a polyolefin-based resin as a sealant, a laminated sheet made from such materials as PET/CPP (nil-ductility polypropylene), PET/LLDPE (linear low density polyethylene), PET/LDPE (low density polyethylene) and the like may be employed.

Further in a case of a combination of ONY (ductile nylon) as a base material and a polyolefin-based resin as a sealant, for instance, a laminated sheet made from such materials as ONY/CPP, ONY/LLDPE, and ONY/LDPE or the like may be employed.

In a case of a combination of a two-layered sheet of PET/ONY as a base material and a polyolefin-based resin as a sealant, for instance, a laminated sheet made from such materials as PET/ONY/CPP, PET/ONY/LLDPE, and PET/ONY/LDPE or the like may be employed.

As the combination each of a base material and a sealant as described above, a combination as ceramic-deposited PET/ONY as a base material and a polyolefin-based resin as a sealant, a combination of ONY/EVOH (ethylene-vinyl alcohol copolymer) as a base material and a polyolefin-based resin as a sealant, and a combination of PET/ONY/AL (aluminum) as a base material and a polyolefin-based resin as a sealant may be employed. The polyolefin-based resin available for this purpose includes CPP, LLDPE, and LDPE.

In a combination of a base material and a sealant, in addition to the polyolefin-based resin, a resin made of a material which can easily be adhered thermally to or separated from the made material may be employed as a sealant. There can be enlisted, for instance, such materials as EVA (ethylene vinyl acetate), a polyolefin-based resin with rubber such as SBS (styrene-butadiene-styrene) rubber or EPR (ethylene-propylene rubber) kneaded therein, and a mixture of PP (polypropylene) and PE (polyethylene).

Further as the laminated sheet, a multilayered sheet such as PP/EVOH/PP or PS (polystyrene)/EVOH/PE or the like may be employed.

As a monolayer sheet, a sheet made from such material as PS, PP, and PE may be employed. The PE includes LLDPE, LDPE, or the like. It is to be noted that the sheet as used herein indicates a concept encompassing even a film with the relatively small thickness.

### BRIEF DESCRIPTION OF DRAWINGS

FIG. 1 is a cross-sectional view showing an atmosphere improving tape for a package according to a first embodiment of the present invention;

FIG. 2 (FIG. 2(A) to FIG. 2(D)) is a cross-sectional view showing a variant of a form of a cross section of the atmosphere improving tape for a package according to the first embodiment;

FIG. 3 is a flat view showing a package in the first embodiment above;

FIG. 4 is a cross-sectional view showing a package in the first embodiment above;

FIG. 5 (FIG. 5(A) to FIG. 5(C)) is a view showing a process of manufacturing the package in the first embodiment above;

FIG. 6 is a cross-sectional view showing a packaging container according to a second embodiment of the present invention;

FIG. 7 is a flat view showing a package according to a third embodiment of the present invention;

FIG. 8 (FIG. 8(A) to FIG. 8(C)) is a cross-sectional view showing a zipper in the third embodiment of the present invention;

FIG. 9 (FIG. 9(A) to FIG. 9(C)) is a view showing a process of manufacturing the package according to a fourth embodiment of the present invention;

FIG. 10 (FIG. 10(A) to FIG. 10(B) is a cross-sectional view showing a variant of the fourth embodiment above:

FIG. 11 is a cross-sectional view showing a packaging container according to a sixth embodiment of the present invention;

FIG. 12 is a flat view showing a package with an atmosphere improving tape according to a seventh embodiment of the present invention;

FIG. 13 is a cross-sectional view showing an atmosphere improving tape in the embodiment shown in FIG. 12;

FIG. 14 is a general view showing a device for manufacturing a package with an atmosphere improving tape in the embodiment shown in FIG. 12;

FIG. 15 is a view showing a step of forming a notched hole in the embodiment shown in FIG. 12;

FIG. 16 is a view showing a step of adhering the tape in the embodiment shown in FIG. 12;

FIG. 17 is a view showing the state where the sheets in the embodiment shown in FIG. 12 have been overlaid on each other;

FIG. 18 is a view showing a step of sealing with ultrasonic waves in the embodiment shown in FIG. 12;

FIG. 19 is a view showing a step of adhering the sheets in the embodiment shown in FIG. 12;

FIG. 20 is a view showing a step of cutting the sheet in the embodiment shown in FIG. 12;

FIG. 21 is a view showing a variant of the cross section of the atmosphere improving tape;

FIG. 22 is a partial flat view showing a first variant of an edge section of the atmosphere improving tape above;

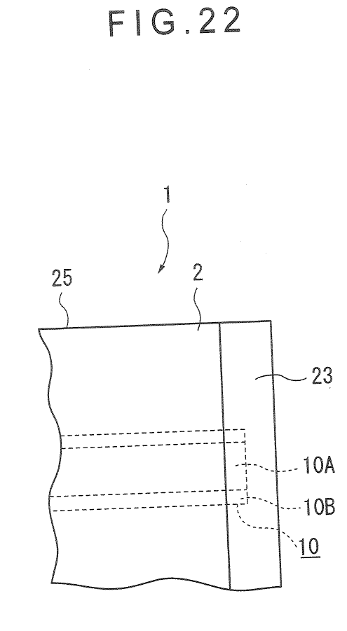

FIG. 23 is a partial flat view showing a second variant of the edge section of the atmosphere improving tape above; and

FIG. 24 is a flat view showing a variant of the tape adhering step above.

### BEST MODE FOR CARRYING OUT THE INVENTION

Embodiments of the present invention are described below with reference to the related drawing.

### First Embodiment

[1] Atmosphere Improving Tape for a Package

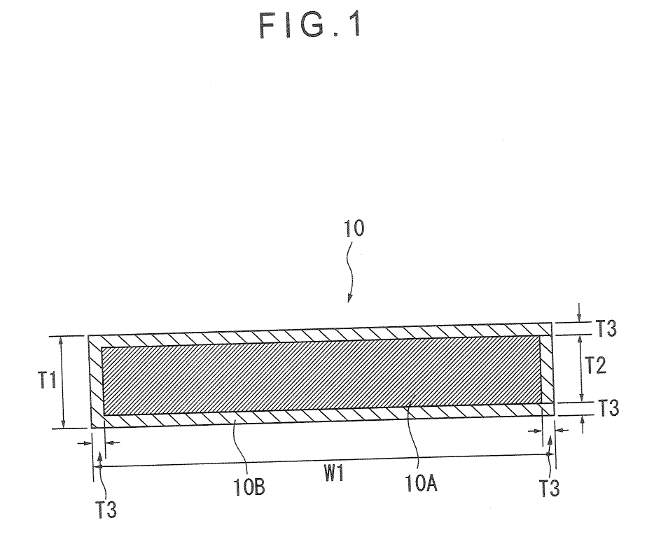

FIG. 1 shows a form of a cross section of a lengthy atmosphere improving tape 10 for a package according to a first embodiment of the present invention

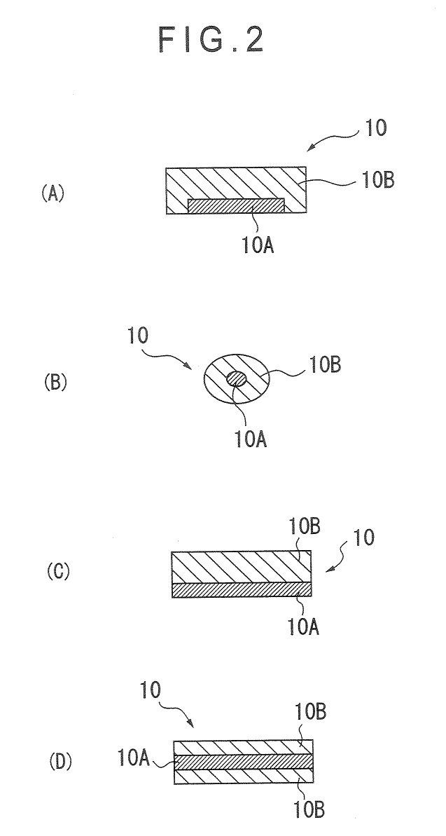

The atmosphere improving tape 10 for a package comprises an inner atmosphere improving layer 10A having a rectangular form and an outer thermoplastic resin layer 10B surrounding the atmosphere improving layer 10A. Other allowable configurations of the cross section include, but not limited to, that in which the atmosphere improving layer 10A is exposed to the outside only in one direction (Refer to FIG. 2(A)), that in which the atmosphere improving layer 10A having a circular form is covered with the thermoplastic resin layer 10B having a doughnut-like form (Refer to FIG. 2(B)), that in which the thermoplastic resin layer 10B is laminated on the atmosphere improving layer 10A (Refer to FIG. 2(C)), and that in which the atmosphere improving layer 10A is held between two thermoplastic resin layers 10B (Refer to FIG. 2(D)).

In the following descriptions, it is assumed that the thickness of the atmosphere improving tape 10 for a package is T₁; the width thereof is W₁, and the thickness of the thermoplastic resin layer 10A is T₂. Further it is assumed that the thickness of the thermoplastic resin layer 10B is T₃.

The atmosphere improving layer 10A contains a material having the atmosphere improving capability. In this embodiment, the atmosphere improving material encompasses a water absorbing material. As the water absorbing material, thermoplastic polyethylene oxide is employed in this embodiment. Other water absorbing materials such as polyacrylate, vinyl acetate/acrylate copolymer, degenerated bridged polyvinyl alcohol, and ultrafine water-absorbing acrylic fiber may be employed.

As a thermoplastic resin for the thermoplastic resin layer 10B, polyethylene (linear low density polyethylene: LLDPE) is employed in this embodiment. In addition, such materials as polyethylene telephthalate, polypropylene, nylon, and a mixture thereof may be employed for this purpose. A form of the atmosphere improving layer 10B in this embodiment is that like a resin. In addition, various forms including those like a sheet, unwoven cloth, and synthetic paper may be employed.

[2] Method of Manufacturing the Atmosphere Improving Tape for a Package

In the method of manufacturing the atmosphere improving tape 10 for a package, materials for the atmosphere improving layer 10A and the thermoplastic resin layer 10B are injection-molded by means of the multi-layer and different form extrusion molding method with a multi-layer and different form extrusion molding device comprising two units of single-spindle extruders, and the atmosphere improving tape 10 for a package as shown in FIG. 1 is molded. Screw diameters of the single-spindle extruders constituting the multi-layer different form extruding device are 30 mmΦ and 40 mmΦ respectively.

[3] Package

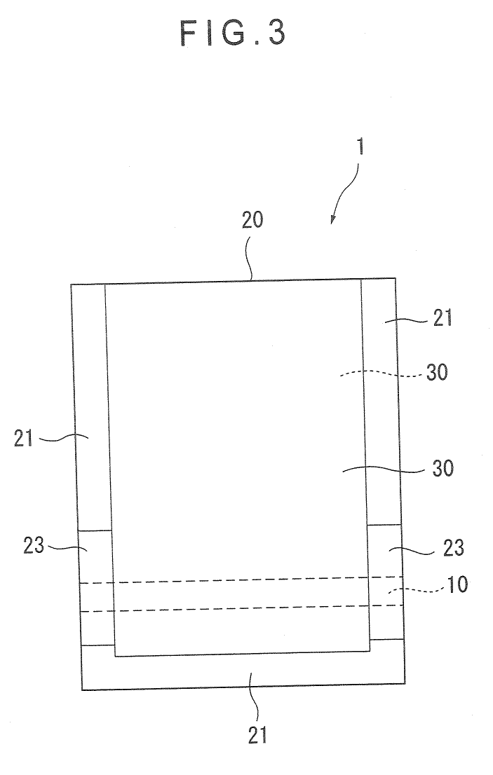

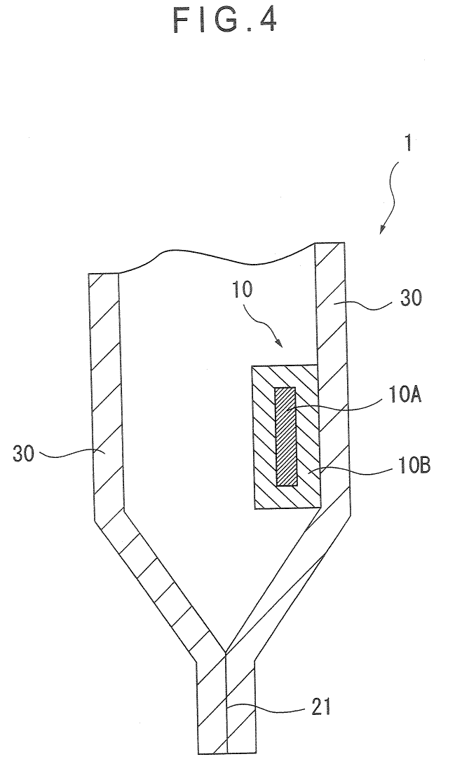

A package 1 which is a package with an atmosphere improving tape comprising two rectangular sheets 30 according to the first embodiment of the present invention is shown in FIG. 3 and FIG. 4. The package 1 comprised two sheets 30, 30, and the atmosphere improving tape 10 for a package. The sheets 30, 30 are overlaid on each other with one edge in the shorter edge side of each sheet defining an opening section 20, and the remaining three edge sections form a heat-sealed section 21. The atmosphere improving tape 10 for a package is adhered to an internal surface of the package 1 in parallel to the opening section 20 at a position close to the short edge side in the opposite side from the opening section 20. The atmosphere improving tape 10 for a package is adhered to the ultrasonically sealed section 23 at a position where the opening section 20 and the heat-sealed section 21 perpendicular thereto cross each other.

As the configuration of the sheet 30, a monolayer product made from linear low density polyethylene (LLDPE) is employed in this embodiment. As other allowable configurations, there can be enlisted a monolayer product made of high density polyethylene, a monolayer product made of polypropylene, polyethylene telephthalate/cast polypropylene telephthalate/aluminum/nylon/linear low density polyethylene, polyethylene telephthalate/ethylene-vinyl alcohol copolymer/nylon/polyolefin-based resin, a layer prepared by vapor-depositing an inorganic material such as silicon oxide or aluminum oxide on polyethylene telephthalate/polyolefin-based resin, polypropylene/ethylene-vinyl alcohol copolymer/polypropylene, nylon/linear low density polyethylene, and as the polyolefin-based resin, for instance, polyethylene or polypropylene can be enlisted.

[4] Method of Manufacturing the Package 1

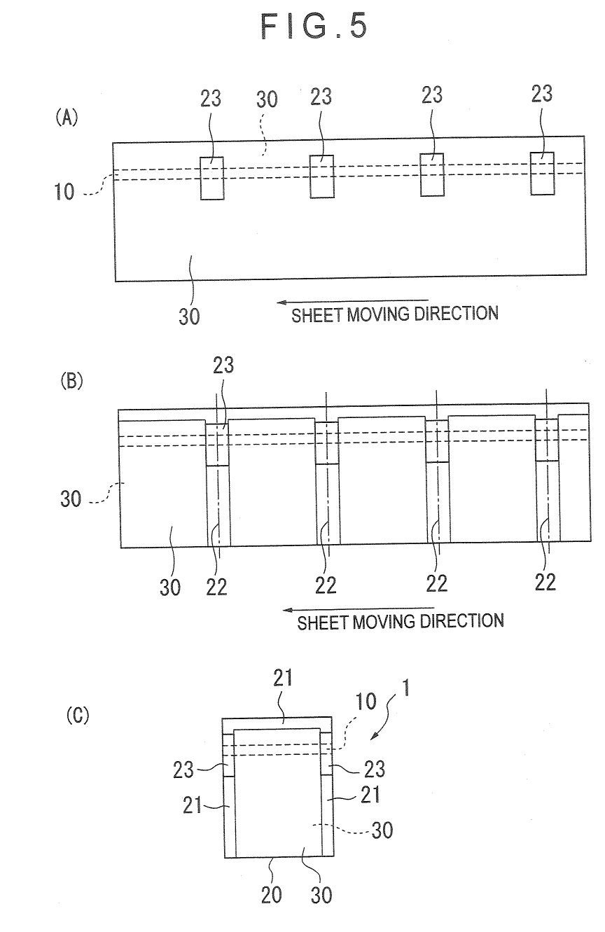

A method of manufacturing the package 1 is described below with reference to FIG. 5.

At first, two sheets 30 (each with the thickness of 40 μm and the width of 400 mm) are continuously fed to a bad-making machine (not shown), and at the same time also the atmosphere improving tape 10 for a package is fed to the bag-making machine. The atmosphere improving tape 10 for a package is adhered, by means of impulse sealing, to the sheet 30 along the longitudinal direction of the sheet 30 (the direction in which the sheet 30 moves) with the same length as that of the sheet 30 and also in parallel thereto with a heating roller incorporated in the bag-making machine (tape adhering step, FIG. 5(A)). In addition to the impulse sealing method, the tape 10 may be thermally adhered to the sheet 30 by heating with a heating roller.

Another sheet 30 is overlaid on the sheet 30 with the atmosphere improving tape 10 for a package having been adhered thereto from the top of the atmosphere improving tape 10 for a package. The sections of the atmosphere improving tape 10 and the sheets 30 overlaid on each other are thermally adhered with the atmosphere improving tape 10 for a package having the same length as that of the opening section 20 of the package 1 provided therebetween to form an ultrasonically sealed section 23.

Then the sheet 30 is divided with the length equal to a shorter edge of the package 1 in the direction perpendicular to the longitudinal direction of the sheet 20 to form a partitioned section 22 including the ultrasonically sealed section 23. Then, heat sealing is performed continuously following the three edges of squared U shape including this partitioned section 22 and the short edge opposite to the short edge forming the opening section 20 of the package 1 (sheet adhering step, FIG. 5(A) and FIG. 5(B)).

The sheets 30, 30 heat-sealed continuously following the squared U shape are cut along a central line of the partitioned section 22 (sheet cutting step, FIG. 5(C)).

With the present invention, the following effects are provided.

(1) The atmosphere improving tape 10 for a package has a form like a tape, and can easily be fixed to the package 1, so that mistaking it for a product or others to be packaged therein never occurs, and therefore wrong use of an atmosphere improving material never occurs. Further, different from a small bag or the like which is a separated body, the tape 10 can be fixed to the package 1 during the process of manufacturing the package 1, so that injection miss of the atmosphere improving material never occurs. Further as the atmosphere improving tape 10 for a package can be adhered to a packaging material such as a sheet in use without adding the atmosphere improving material into the sheet 30, there is no need of taking into consideration a combination of the atmosphere improving material and the sheet 30 as a packaging material, so that a packaging material for the package 1 can freely be selected. Further as the atmosphere improving material is contained only in the atmosphere improving tape 10, loss during the process of manufacturing the package 1 can be reduced, and excessive load to the environment never occurs. Further the atmosphere improving layer 10A has a cross section covered with the thermoplastic resin layer 10B, so that leakage of the atmosphere improving material from the atmosphere improving tape 10 for a package never occurs, and therefore a product or the like within the package 1 is not contaminated.

(2) As the atmosphere improving tape 10 for a package is thermally adhered to an internal surface of the sheet 30 continuously during the process of forming the package 1, and different from the case in which a sheet having the atmosphere improving layer 10A itself is manufactured as a package, the atmosphere improving tape 10 for package is adhered within the package 1, so that there is no waste and the cost is low, and further the atmosphere improving capability can easily be given to the package 1.

In addition, as the atmosphere improving tape 10 for a package is thermally adhered to the sheet 30, different from the case where it is adhered to the sheet 30 with an adhesive or the like, no odor is generated, and the heat resistance is high, so that the atmosphere improving tape 10 for a package can be applied even to boiled or pouch-packed foods.

### Second Embodiment

A second embodiment of the present invention is described below. It is to be noted that the same signs are assigned to the same sections and members as those already described above and detailed descriptions thereof are omitted herefrom.

[1] Atmosphere Improving Tape for a Package

The atmosphere improving tape 10 for a package according to the second embodiment is different from the atmosphere improving tape 10 for a package according to the first embodiment only in the point that the atmosphere improving layer 10A employs a form of the cross section (FIG. 2(D)) laminated in the state where it is held between the two thermoplastic resin layers 10B.

The atmosphere improving tape 10 for a package according to the second embodiment is different from the atmosphere improving tape 10 for a package according to the first embodiment also in the point that the atmosphere improving layer 10A employs a volatile antirust agent as an atmosphere improving material in this embodiment. As the volatile antirust agent, benzoic acid is employed. As the volatile antirust agent, there can also be enlisted a biannulate benzoazole compound, a mononuclear imidazole, triazole, rosin, diisopropyl nitrite, cabrylic acid, dicyclohexil nitrite ammonium, dicyclo carbonate ammonium, and nitrite.

[3] Packaging Container 2

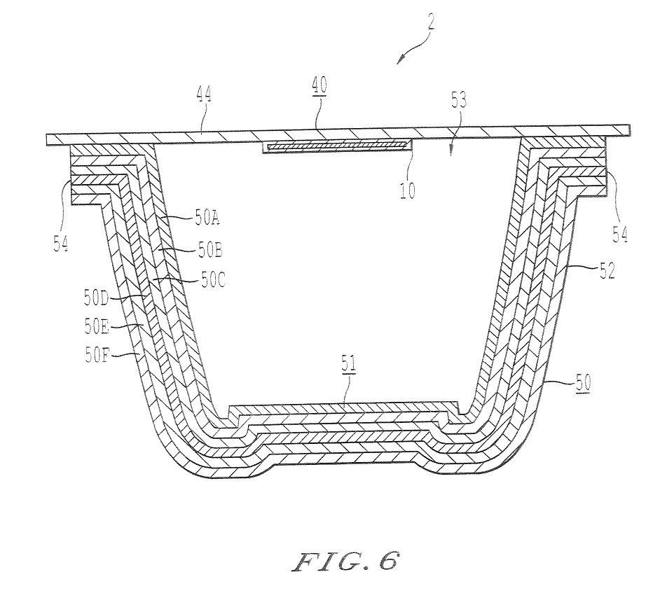

A packaging container 2 comprises a cover member 40 and a molded container 50 as shown in FIG. 6. The circular cover member 40 functions as a cover for the packaging container 2 with the circular peripheral portion adhered to the molded container 50, and comprises a base material sheet 41 and the atmosphere improving tape 10 for a package adhered to a central portion of a rear surface of the base material sheet 41. The base material sheet 41 comprises, from the outer side, polyethylene telephthalate, nylon, ethylene-vinyl alcohol copolymer, and linear low density polyethylene. The atmosphere improving tape 10 for a package is adhered to a circular rear surface of the base material sheet 41.

The molded container 50 comprises a side face portion 52 molded in the state where it erects from a periphery of a circular bottom surface 51, an opening portion 53 formed on an upper edge surrounded by this side face portion 52, and a flange portion 54 extending outward from a periphery of the opening portion 53.

The side face portion 52 has a tapered form tapering from the opening portion 53 to the bottom surface portion 51.

Herein the molded container 50 is based on the configuration in which a fissile layer 50A, a base material layer 50B, an adhesive layer 50C, a gas barrier layer 50D, an adhesive layer 50E, and a base material layer 50F are overlaid in this order from the inner side to form a multilayered sheet. This multilayered sheet comprises, from the side of the fissile layer 50A, a fissile layer made of high density polyethylene; a base material layer made of polypropylene; an adhesive layer made of maleic acid anhydrate degenerated polypropylene; a gas barrier layer made of ethylene-vinyl alcohol copolymer; an adhesive layer made of maleic acid anhydrate degenerated polypropylene; and a base material layer made of polypropylene.

[4] Method of Manufacturing the Packaging Container 2

The method of manufacturing the packaging container 2 is described below with reference to FIG. 6. At first, the atmosphere improving tape 10 for a package is thermally adhered with a heating roller continuously on a central portion of a rear surface of the base material sheet 41 as a base material. Then a potion of the cover member 40 is adjusted so that the atmosphere improving tape 10 for a package corresponds to the flange portion 54 of the molded container 50, and is then sealed by means of heat sealing, and then the atmosphere improving tape 10 for a package is punched out with a circular form along a periphery of the container.

With the embodiment as described above, the following effect can be obtained in addition to those in the first embodiment.

(3) As the atmosphere improving tape 10 for a package is thermally adhered to an internal surface of the cover member 40, different from the case in which a sheet having the atmosphere improving layer 10A is manufactured as a cover member, the cover member 40 is separated from the atmosphere improving tape 10 for a package, so that the atmosphere improving capability can easily be given to the packaging container 2.

### Third Embodiment

A third embodiment of the present invention is described below.

A package 3 with a zipper according to the third embodiment of the present invention has a zipper 14 having an atmosphere improving layer therein and adhered to inside of the package 3 in parallel to the opening section 20.

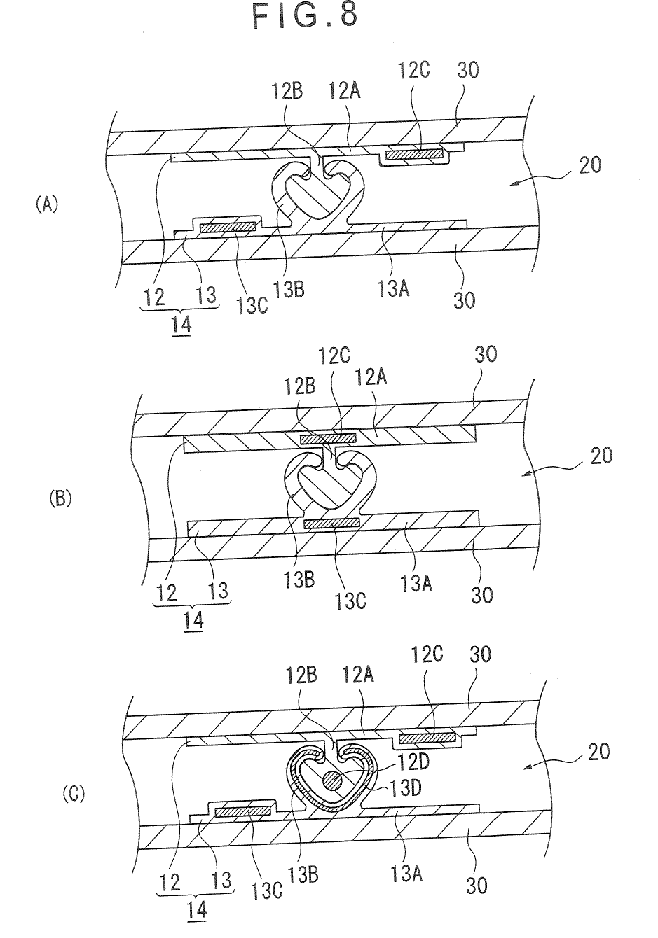

The zipper 14 comprises a male member 12 and a female member 13 as shown in FIG. 8(a). The male member 12 comprises a belt-formed base section 12A and a male engagement section 12B having a heart-shaped cross section. The belt-formed base section 12A and the male engagement section 12B are made of a polypropylene resin. Formed inside the belt-formed base section 12A is an atmosphere improving layer 12C covering a cross section of the belt-formed section 12A. An atmosphere improving material contained in this atmosphere improving layer 12C is a deoxidizing agent. Metallic powder such as iron or zinc may be used as the deoxidizing agent.

The female member 13 comprises a belt-formed base section 13A and a female engagement section 13B having a concave cross section. The belt-formed base section 13A and the male engagement section 12B are made of a polypropylene resin. Formed inside the belt-formed base section 13A is an atmosphere improving layer 13C covering a cross section of the belt-formed section 13A. An atmosphere improving material contained in this atmosphere improving layer 13C is a deoxidizing agent. Metallic powder such as iron or zinc may be used as the deoxidizing agent.

In FIG. 8(a), the atmosphere improving layers 12C and 13C are formed inside the belt-formed base section 12A of the opening section 20 of the male member 12 and inside of the belt-formed base section 13A in the opposite side from the opening section 20 of the female section 13 respectively.

Further, the configuration is allowable in which the atmosphere improving layers 12C and 13C are formed inside the belt-formed base section 12A just below the male engagement section 12B of the male member 12 and inside the belt-formed base section 13A just below the female engagement section 13B of the female member 13 respectively as shown in FIG. 8(b).

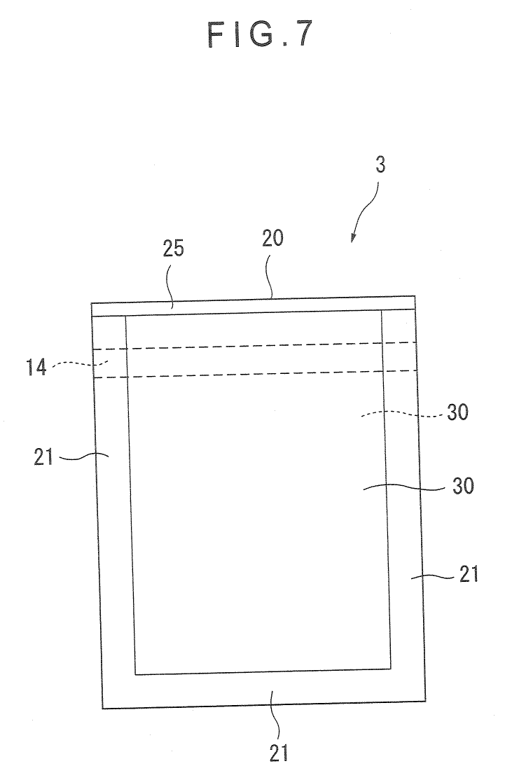

This embodiment is different also in the point that the opening section 20 of the package 3 is sealed as a heat-sealed section 25 as shown in FIG. 7.

Further as shown in FIG. 8(c), by forming the atmosphere improving layers 12D and 13D inside the engagement sections 12B, 13B of the male member 12 and female member 13 respectively, it is possible to further improve the deoxidizing capability as well as the capability for preventing corrosion of the contents in the package 3 with a zipper.

In the package 3 with a zipper, the sheets 30, 30 are overlaid with the opening section 20 formed along the shorter edges thereof, and the remaining three edges form the heat-sealed sections 21. The sheet 30 has a rectangular flat surface, and is based on a bilayer structure comprising NY (nylon) and LLDPE (linear low density polyethylene).

The package 3 with a zipper is manufactured according to the following sequence.

At first the zipper 14 is manufactured with the form as described above by means of extrusion molding with a die. A material for this zipper 14 is a polypropylene resin.

Then the zipper 14 is thermally adhered along one edge of the sheet 30. Then the two sheets 30, 30 each with the zipper 14 having been fused thereto are thermally fused and adhered to each other by means of heat sealing along the remaining three edges for sealing.

Then, when used, the contents to be packaged is put in the package 3 with a zipper, the zipper 14 is engaged with the opening section 20 heat-sealed to form a heat-sealed section 25, thus the package 3 with a zipper is completely tight-sealed.

With the embodiment of the present invention as described above, the following effects are provided in addition to those obtained in the first embodiment described above.

(4) As the belt-formed base sections 12A and 13A have the atmosphere improving layers 12C and 13C respectively, the deoxidizing capability can easily be given without the need of separately adhering an atmosphere improving tape for a package.

Further as the package 3 with a zipper can be opened and closed repeatedly, the package 3 with a zipper is well suited to applications in which the package 3 is used several times.

It is to be noted that the following variants are also encompassed in the first to third embodiments described above.

For instance, as the atmosphere improving materials, there can be enlisted, in addition to a water absorbing material, a drying agent, a volatile antirust agent, and a deoxidizing agent, a volatile antibiotic agent, a volatile preservative against mold, a volatile antitick agent, a volatile insect repellent, a deodorant, a volatile animal repelling agent, an absorbent, or a mixture thereof.

As the volatile antibiotic agents, there can be enlisted such materials as isocyanic acid compounds, Japanese cypress thiol, oil extracted from bamboo, oil extracted from beefsteak plant, and thiazolyl sulfamide compounds.

As the volatile preservatives against mold available, there can be enlisted such materials as organic tin compounds, organic sulfur compounds, chlorine-based compounds, phenol-based compounds, and thymol.

As the volatile antitick agents, there can be enlisted such materials as allethrin, tetramethrin, lesmethrin, phenotoframethrin, permethrin, diphenothrin, tralomethrin, empenthrin, DDVP, fenithion, temephos, diflubenzron, buprofedin, pyriproxiphen, and mentha oil.

As the volatile insect repellants, there can be enlisted such materials as cresol, O-phenyl phenol, parathion, and imidazole.

As the deodorant, there can be enlisted such materials as silica gel, active alumina, titanium oxide, zinc oxide, carbon black, and zeolite.

As the volatile antirust agents, there can be enlisted such materials as biannulate benzoazole compounds, mononuclear imidazole, triazole, rosin, diisopropyl nitrite ammonium, benzoic acid, cabrylic acid, dicyclohexil nitrite ammonium, dicyclo carbonate ammonium, and nitrite.

As the volatile animal-repelling agents, there can be enlisted such materials as pyrethrin, rotenone, phthalthrin, allethrin, permetrin, cybermethrin, alpha cybermethrin, phenothrin, diphenothrin, menthol, Japanese cypress oil, Japanese cedar oil, Hiba oil, dithiocarbamoryl sulfide compounds, cynnamic aldehide, and linalool.

As the absorbents, there can be enlisted such materials as calcium oxide, an alumina drying agent, silica gel, magnesium salt, and zeolite.

Although the multilayer and different form extrusion method was employed as a method of manufacturing the atmosphere improving tape 10 for a package and the zipper 14 in the embodiment described above, but the present invention is not limited to this case, and various method can be employed including a method in which an oxygen absorbing material is filled in a thermoplastic resin tube and is thermally applied, for instance, by a heating roller, a method in which an oxygen absorbing material is filled between unwoven or woven clothes made of a thermoplastic resin, covered with a thermoplastic resin sheet or the like, and is thermally applied, a method in which an oxygen absorbing resin is filled in a thermoplastic resin tube, or the like.

Forms of the package 1, 3 include a portrait type pillow bag, a landscape type pillow bag, a bag sealed along four edges, a bag sealed along three edges, a gazette bag, a self-sustaining bag, a folded box, and the like, although a bag sealed along three edges is employed in the embodiments described above.

Although the atmosphere improving tape 10 for a package was adhered near an area opposite to an opening section of the package or on a rear surface of the cover member of the packaging container in the embodiment described above, but the present invention is not limited to this case, and the atmosphere improving tape 10 for a package can be adhered in any portion such as an intermediate portion of the opening section, or on the entire surface of the cover member of the packaging container, or on an internal surface of the packaging container.

Arrangement of the atmosphere improving layers 12C, 13C, 12D, and 13D in the engagement section 14 are not limited to the combinations shown in Fig. (A), FIG. 8(B), and FIG. 8(C), and may be arranged in either one of the engagement sections 12B or 13B. Further although the atmosphere improving layers 12C, 13C, 12D, and 13D are arranged in either one of the belt-form base sections 12A and 13A, it is preferable to arrange the layers in the side opposite to the opening section 20.

Although PP (polypropylene) was employed as a material for the zipper 14 in the embodiment described above, LDPE (low density polyethylene) or LLDPE (linear low density polyethylene) may be employed.

Further, NY (nylon) and LLDPE (linear low density polyethylene) were employed as materials for the sheet 30, but the present invention is not limited to this case, and such materials as PET (polyethylene telephthalate) or CPP (cast polypropylene) may be employed in place of NY (nylon), and also such materials as LDPE (low density polyethylene) or PP (polypropylene) may be employed in place of LLDPE (linear low density polyethylene).

In a case of a monolayer structure, such materials as PET (polyethylene telephthalate) or CPP (cast polypropylene) may be employed.

Other structures and forms may be employed for carrying out the present invention so long as the objects of the present invention can be achieved.

The present invention is described in more details with reference to examples and comparative examples. It is to be noted that the present invention is not limited to the contents of the examples described below.

### EXAMPLE 1

In the first embodiment, the atmosphere improving tape 10 for a package (capable of absorbing water) was manufactured under the following conditions.

The screw diameters of the monaxial extruder in the multilayer different from extruding device were 30 mmΦ and 40 mmΦ respectively.

Atmosphere improving layer 10A: Thermoplastic polyethylene oxide (produced by Sumitomo Seika Chemicals Co., ltd., Aquacoke)

Thermoplastic resin layer 10B: LLDPE (produced by Idemitsu Polyethylene, 0238 CN)

The production rate was 25 m/min (discharge rate: 13 Kg/hour)

Thickness T₁ of the atmosphere improving tape 10 for a package: 300 μm

Width W₁ of the atmosphere improving tape 10 for a package: 30 mm

Thickness T₂ of the atmosphere improving layer 10A: 200 μm

Thickness T₃ of the thermoplastic resin layer 10B: 50 μm

In the first embodiment, the package 1 was manufactured under the following conditions.

Configuration of the sheet 30: LLDPE (produced by Idemitsu Polyethylene, 0238 CN)

Size of the ultrasonic seal 23: 40 mm×20 mm

Pitch of the ultrasonic seal 23: 300 mm

Width of the heat-sealed section 21 in the opposite side to the opening section 20: 10 mm

Width of the heat-sealed section 21 at a position where it crosses the opening section 20 at right angles: 30 mm

Only in Example 1, holes each having the diameter of 2 mm were prepared on the atmosphere improving tape 10 for a package with a space of 5 mm in both the sideward and longitudinal directions, and then the package 1 was formed.

The bag-making rate was the same as that employed when the atmosphere improving tape 10 for a package was not applied, and the package 1 could easily be manufactured.

Three packs of 200 g raw chicken meat each packaged with a trace stretch were put in the package in Example 1, and were left in the state where the chicken meat packs were self-sustaining, but meat juice was not leaked into the package, and hands were kept clean when the three packs of raw chicken meat trays were taken out from the package.

### EXAMPLE 2

In the first embodiment, the atmosphere improving tape 10 for a package (with the antitick characteristics) was manufactured under the following conditions.

Atmosphere improving layer 10A: LLDPE with prescribed mentha oil added with 1 weight %

Thermoplastic resin layer 10B: LLDPE (Idemitsu Polyethylene 0238CN)

In the process of manufacturing the atmosphere improving tape 10 for a package, the atmosphere improving tape 10 for a package was cooled and pulled out after different form extrusion being cooled in a water bath, and odor due to the mentha oil was not generated, but the odor by mentha oil was generated in a feed injection hopper. However, as the extruder was of compact size, so that the problem of odor was easily solved only by providing an exhaust air duct on the feed injection hopper.

The sheet 30 in the package 1 had the width of 1000 mm and comprised O-nylon and LLDPE (15 μm and 60 μm respectively). A central portion of the heat sealed section was cut with a space of 1200 mm to obtain a package with the dimensions of 1000 mm×1200 mm. Other conditions were the same as those employed in Example 1.

30 individual bodies of white tick were enveloped by filtering paper and put in a package manufactured under the same conditions as those employed in Example 2. The filtering paper was bent so that the white ticks would not escape. This package was placed in a futon folded twice, and the futon was put in the package obtained in Example 2 with the opening section of the bag tight-sealed with a clip. The package was left for three days at the room temperature, and then the package was opened, and the state of the ticks was visually observed to find that all of the 30 individual bodies of the ticks were killed.

### EXAMPLE 3

In the first embodiment, the atmosphere improving tape 10 for a package (having the antibiotic characteristics) was manufactured under the following conditions.

Atmosphere improving layer 10A: Resin prepared by adding granulized Japanese cypress thiol by 0.2% by weight to LLDPE

Thermoplastic layer 10B: LLDPE (Idemitsu polyethylene 0238CN)

In the process of manufacturing the atmosphere improving tape 10 for a package, the atmosphere improving tape 10 for a package was cooled and pulled out after different form extrusion being cooled in a water bath, and vapor of Japanese cypress thiol was generated little, and vapor of Japanese cypress thiol generated from the feed injection hopper was prevented from flowing into the atmosphere by providing an exhaust air duct on the hopper and passing the exhaust air through a deodorizing device (manufactured by Kureha Techno Eng Co., ltd., GASTAK HS type). The generated Japanese cypress thiol could easily be processed, because the extrusion device was of compact size.

In the first embodiment, the package 1 was manufacture under the following conditions.

Configuration of the sheet 30: O-nylon/LLDPE (15 μm/60 μm)

Size of the ultrasonic seal 23: 35 mm×20 mm

Pitch of the ultrasonic seal 23: 300 mm

Width of the heat-sealed section 21 in the side opposite to the opening section 20: 10 mm

Width of the heat-sealed section 21 on the edge perpendicular to the opening section 20: 20 mm

0.4 ml of a suspension of yellow staphylococci (IF012732) conditioned in a common bouillon medium and diluted to 1/500 was dripped into a bouillon agar medium in a petri plate and spread on a surface of the agar medium.

The petri plate with the yellow staphylococci spread thereon was packaged with the package 1 manufactured in EXAMPLE 3, and the opening section 20 was tight-sealed with an impulse sealer. A colony of the yellow staphylococci was not generated even after culturing for 5 days at the temperature of 35° C.

### EXAMPLE 4

The atmosphere improving tape 10 for a package (capable of preventing mold) was manufactured under the same conditions as those in Example 3 except that a resin prepared by adding orthophenyl phenol by 0.2% by weight to LLDPE was used for the atmosphere improving layer 10A.

The package 1 was manufactured under the same conditions as those employed in Example 3.

5 pieces of Onshu orange were put in the package obtained in Example 4 and an opening section of the package was sealed with document clips at two places. The sample was left for two weeks at the room temperature, but generation of mold was not observed visually.

### EXAMPLE 5

The insect repelling capability was assessed by using the package obtained in Example 4.

Namely, 1 kg of leaf soil collected in a mountain was filled in the package obtained in Example 4 with the opening section sealed with an impulse sealer, and the sample was stored at a dark place for one week at the room temperature. The package was opened in one week, and whether worms were living in the leaf soil or not was visually observed, but a living worm was not observed.

### EXAMPLE 6

In the first embodiment, the atmosphere improving tape 10 for a package (dry and with the deodorizing capability) was manufactured under the following conditions.

Atmosphere improving layer 10A: PP (the following PP) 40% by weight, calcinated lime 30% by weight, and active alumina 30% by weight pelletized by the hot cut system

Thermoplastic resin layer 10B: PP (manufactured by Idemitsu Petrochemical Co., Ltd., Idemitsu polypropylene E-304GP)

The atmosphere improving tape 10 for a package having the cross section as shown in FIG. 2(D) was manufactured. The conditions for manufacture were the same as those employed in Example 3 except the point that OPP/CPP (40 μm/50 μm) were used in place of the O-nylon/LLDPE (15 μm/60 μm).

10 sheets of dried and baked laver were put in the package obtained in Example 6. This tight-sealed packaging bag was stored at a dark place for one week at 40° C. under the relative humidity of 90%, and then the baked laver was visually observed, but any specific color change or moistening was not observed.

Similarly two dried herrings dried overnight were put in the package obtained in Example 6, and the opening was heat-sealed without exhausting the air inside the package. This package was left in a refrigerator for two weeks, and then the contents was checked. The state was little changed from that before sealing.

### EXAMPLE 7

In the first embodiment, the atmosphere improving tape 10 for a package (having the animal repelling capability) was manufactured under the following conditions.

Atmosphere improving layer 10A: Resin prepared by adding cinnamic aldehyde by 1% by weight to LLDPE

Thermoplastic resin layer 10B: LLDPE (Idemitsu polyethylene 0238CN)

The atmosphere improving tape 10 for a package having the cross section as shown in FIG. 1 was manufactured under the conditions described above. Further a package with this atmosphere improving tape 10 for a package adhered thereon was manufactured under the same conditions as those employed in Example 2.

50 g of cut pieces of dried bonito was filled in the package obtained in Example 7, and an opening section of the package was tight-sealed by heat sealing. This package was given to a cat without opening it to check whether the cat ate it or not, but the cat did not try to eat it.

### EXAMPLE 8

In the second embodiment, the atmosphere improving tape 10 for a package (with the antirust property) was manufactured under the following conditions.

Atmosphere improving layer 10A: Resin prepared by adding benzoic acid by 1% by weight to LLDPE

Thermoplastic resin layer 10B: LLDPE (Idemitsu polyethylene 0238CN)

The atmosphere improving tape 10 for a package having the cross section as shown in FIG. 1 was manufactured under the conditions as those employed in Example 2. Further a package with this atmosphere improving tape 10 for a package adhered thereto was manufactured under the same conditions as those employed in Example 2.

The packaging container according to the second embodiment of the present invention was manufactured. Specifically, a base material sheet 41 (polyethylene telephthalate (12 μm)/nylon (15 μm). ethylene-vinyl alcohol copolymer (12 μm/linear low density polyethylene (50 μm)) for forming a cover member with the width of 100 mm was fed out from a cover material feed-out section of a successive cup sealer, and was thermally adhered to the atmosphere improving tape 10 for a package being inserted from the LLDPE side. The molded container 50 had the outer diameter of 80 mmΦ and the depth of 20 mm, and then a gear with the diameter of 70 mmΦ was filled in the molded container 50 with the cover member thermally adhered to the molded container 50. Layer structure of the molded container 50 was high density polyethylene (20 μm)/polypropylene (150 μm)/maleic acid anhydrate degenerated polypropylene (10 μm)/ethylene-vinyl alcohol copolymer (20 μm)/maletic acid anhydrate degenerated polypropylene (10 μm)/polypropylene (150 μm), and the total thickness was 360 μm. The interface adhesion strength between the high density polyethylene (20 μm) and the polypropylene (150 μm) was about 0.8 kg/15 mm in width.

The gear was put in the packaging container obtained in Example 8, and the package was left for two weeks at the temperature of 40° C. and under the relative humidity of 90%. Then the gear was checked for generation of rust, but rust was not observed. When opening the cover member, as the high density polyethylene (20 μm) could be separated together with the cover member at the interface between the high density polyethylene (20 μm) and the polypropylene (150 μm) in the molded container, so that the packaging container could easily be opened.

### EXAMPLE 9

In the third embodiment, the zipper 14 (having the oxygen absorbing capability) was manufactured under the following conditions.

Screw diameters of a single-spindle extruder of the multilayer different from extruding device were 30 mmΦ and 40 mm Φ respectively.

Atmosphere improving layers 12C, 13C: Master batch in which the weight ratio of polypropylene (Idemitsu polypro E-170 GM) and iron powder-based deoxidizing agent (comprising iron powder with the bulk specific weight of 2.0 or more and specific surface area of 0.5 or more and salt of 60:40

Thermoplastic resin for the belt-formed base sections 12A, 13A: Polypropylene (Idemitsu polypro E-170 GM)

The positions at which the atmosphere improving layers 12C and 13C formed as described above were symmetric against the male engagement section 12B and female engagement section 13B as a central axis.

Then two laminated sheets each of ONY/EVOH/LLDPE (15 μm/12 μm/60 μm) and having the width of 300 mm were used as the sheet for the package with the zipper 14 adhered thereto. The male member 12 and female member 13 of the zipper 14 were adhered to inside of the two sheets and were applied and thermally applied thereto with a heating roller continuously in the direction parallel to the flow direction of the two sheets. Then the zipper 14 was engaged between the two sheets and ultrasonic sealing with the tip of 35 mm×20 mm was performed crushing the zipper 14. Then a bag was formed with the sheets to obtain the package 3.

The zipper having this atmosphere improving layer may be manufactured by a general-purpose machine, and therefore any specific facility is not required, and a package which can easily be opened and closed in repetition and has the oxygen absorbing capability could be obtained.

700 cc of water and 100 cc of air were filled in this package and the package was tight-sealed, and sterilization was carried out by boiling the package for 30 minutes at 90° C. This package was left for three days at the room temperature, and the oxygen density was measured to find that the oxygen density was 0%.

### COMPARATIVE EXAMPLE 1

A package was manufactured under the same conditions as those employed in Example 1 except that the atmosphere improving tape 10 for a package (with the water-absorbing capability) was not used.

Three packs of raw chicken meat each having the weight of about 200 g and packed with a trace stretch were put in the package prepared as described above, and the chicken meat package was left in the self-sustaining state for 30 minutes, but the meat juice leaked from the trace stretch was kept inside the package, and when the three raw chicken meat trays were taken out from the package, operator's hands were contaminated.

### COMPARATIVE EXAMPLE 2

A package was manufactured under the same conditions as those employed in Example 2 except that the atmosphere improving tape 10 for a package (with the antitick property) was not used.

30 individual bodies of white tick were enveloped by filtering paper and put in a package manufactured under the same conditions as those employed in Example 2. The filtering paper was bent so that the white ticks would not escape. This package was placed in a futon folded twice, and the futon was put in the package obtained in Example 2 with the opening section of the bag tight-sealed with a clip. The package was left for three days at the room temperature, and then the package was opened, and the state of the ticks was visually observed to find that all of the 30 individual bodies of the ticks were still alive.

### COMPARATIVE EXAMPLE 3

A package was manufacture under the same conditions as those employed in Example 3 except that the atmosphere improving tape 10 for a package was not used.

0.4 ml of a suspension of yellow staphylococci (IFO12732) conditioned in a common bouillon medium and diluted to 1/500 was dripped into a bouillon agar medium in a petri plate and spread on a surface of the agar medium.

The petri plate with the yellow staphylococci spread thereon was packaged with the package 1 described above, and the opening section 20 was tight-sealed with an impulse sealer. After the sample was left for 5 days at 35° C., a number of colonies of yellow staphylococci were observed.

### COMPARATIVE EXAMPLE 4

A package was manufactured liken in Example 3.

5 pieces of Onshu orange were put in the package obtained as described above and an opening section of the package was sealed with document clips at two places. The sample was left for two weeks at the room temperature to find that Penicillium had been generated on two pieces of oranges.

### COMPARATIVE EXAMPLE 5

The insect repelling capability was assessed using the package obtained in Example 3.

Namely, after 1 kg of leaf soil collected in a mountain was filled in the package obtained in Comparative Example 3 with the opening section tight-sealed by an impulse sealer, and the package was stored at a dark place for one week at the room temperature. In one week, the package was opened, and whether worms in the leaf soil were living or not was visually checked to find that 12 worms were alive.

### COMPARATIVE EXAMPLE 6

A package was manufactured under the same conditions as those employed in Example 6 except that the atmosphere improving tape 10 for a package (dried and having the deodorizing capability) was not used.

10 sheets of dried and baked laver were put in the package obtained as described above. This tight-sealed packaging bag was stored at a dark place for one week at 40° C. and under the relative humidity of 90%, and then the baked laver was visually observed to find that color of the baked laver had been changed to red with the laver itself moistened.

Similarly two dried herrings dried overnight were put in the package obtained as described above, and the opening was heat-sealed without exhausting the air inside the package. This package was left in a refrigerator for two weeks, and then the contents was checked to find that volatile nitrogen odor was sensed.

### COMPARATIVE EXAMPLE 7

A package was manufactured under the same conditions as those employed in Example 7 except that the atmosphere improving tape 10 for a package (having the animal repelling capability) was not used.

50 g of cut pieces of dried bonito was filled in the package obtained as described above, and an opening section of the package was tight-sealed by heat sealing. This package was given to a cat without opening it, and the cat ate it immediately.

### COMPARATIVE EXAMPLE 8

A packaging container was manufactured under the same conditions as those employed in Example 8 except that the atmosphere improving tape 10 for a package (with the antirust property) was not used.

A gear was put in the packaging container obtained as described above, and the package was left for two weeks at the temperature of 40° C. and the relative humidity of 90%. Then the gear was checked for generation of rust, and brown rust was generated at the contacting portion between the gear and the molded container.

### COMPARATIVE EXAMPLE 9

A package was manufactured under the same conditions as those employed in Example 9 except that the atmosphere improving layer (having the oxygen absorbing capability) was not used with the zipper 14.

700 cc of water and 100 cc of air were filled in this package and the package was tight-sealed, and sterilization was carried out by boiling the package for 30 minutes at 90° C. This boiled package was left for three days at the room temperature, and the oxygen density was measured to find that the oxygen density was 20.1%.

### COMPARATIVE EXAMPLE 10

A three layered sheet was manufactured with three units of extrusion device comprising screw diameter of 50 mmΦ, 65 mmΦ and 50 mmΦ respectively and a coextrusion T die casting sheet manufacturing unit with a 900 mm T die and an air knife pick up device installed. The configuration of this three layered sheet was LLDPE/LLDPE with prescribed menthe oil added with 1 weight/and LLDPE, corresponding to the three units of extrusion device respectively. Then a package was manufactured liken in Example 2.

Compared to the case of Example 2 where an atmosphere improving tape for a package was used, the system was large-scale and large quantity of resin was discharged, so that the odor by the menthe oil was mostly generated in a T die and the problem of odor was not easily solved.

### REFERENCE EXAMPLE 1

A cover member was manufactured under the same conditions as those in Example 8. Meanwhile a molded container similar to that in Example 8 was made from a monolayer polyethylene sheet having the total thickness of 340 μm, a gear was put in the molded container liken in Example 8.

The cover member was sealed to the molded container, but the adhesion was failed due to the different materials.

### REFERENCE EXAMPLE 2

A cover member was manufactured under the same conditions as those in Example 8. Meanwhile a molded container similar to that in Example 8 was made from a monolayer polyethylene sheet having the total thickness of 340 μm, and a gear was put in the molded container liken in Example 8.

The cover member was sealed to the molded container, but the adhesion strength was too strong to enable open and shut of the cover member.

From the respective comparison between Example 1 and Comparative Example 1, Example 2 and Comparative Example 2, Example 3 and Comparative Example 3, Example 4 and Comparative Example 4, Example 5 and Comparative Example 5, Example 6 and Comparative Example 6, Example 7 and Comparative Example 7, Example 8 and Comparative Example 8, Example 9 and Comparative Example 9, it has been confirmed that the atmosphere is improved in each example where an atmosphere improving tape for a package according to this invention is used.

Also comparing Example 2 and Comparative Example 10, as an atmosphere improving tape for a package was used in Example 2, the amount of atmosphere improving material was little, and so that the problem of odor and the like was not generated.

### Performance Evaluation

From the results described in these examples and comparative examples, it will be recognized that the excellent performance of this invention has become apparent.

### Fourth Embodiment

A fourth embodiment of the present invention is described below.

[1] Oxygen Absorbing Tape

FIG. 1 shows a form of a cross section of a lengthy oxygen absorbing tape 10 according to a fourth embodiment of the present invention.

The oxygen absorbing tape 10 comprises an inner oxygen absorbing layer 10A having a rectangular form and an outer thermoplastic resin layer 10B surrounding the oxygen absorbing layer 10A.

In the following description, it is assumed that the thickness of the oxygen absorbing tape 10 is T₁; the width thereof is W₁; the thickness of the oxygen absorbing layer 10A is T₂, and the thickness of the thermoplastic resin layer 10B is T₃.

The oxygen absorbing layer 10A comprises a material with oxygen absorbing characteristic. As the oxygen absorbing material, metallic powder of such metals as iron and zinc is employed. In addition, such materials as oxides with low reducing capability of iron such as FeO, FeTiO₂, and Fe₂O₃, sulfite salt, bisulfite, tiosulfate salt, oxalates, pyrogallol, catechol, longalit, glucose, vitamin C, oxygen absorbing polyester. may be employed for this purpose.

As a thermoplastic resin for the thermoplastic resin layer 10B, polypropylene is employed in this embodiment. In addition, such materials as polyethylene telephthalate, polyethylene, nylon, and a mixture thereof may be employed for this purpose. A form of the thermoplastic resin layer 10B in this embodiment is that like a resin. In addition, various forms including those like a sheet, unwoven cloth, and synthetic paper may be employed.

[2] Method of Manufacturing the Oxygen Absorbing Tape

In the method of manufacturing the oxygen absorbing tape, materials for the oxygen absorbing layer 10A and the thermoplastic resin layer 10B are injection-molded by means of the multilayer and different form extrusion molding method with a multilayer and different form extrusion molding device comprising two units of mono-axial extruders, and the oxygen absorbing tape 10 in FIG. 1 is molded.

[3] Package

A package 1 which is a package with an oxygen absorbing tape comprising two rectangular sheets 30 according to the fourth embodiment of the present invention is shown in FIG. 2 and FIG. 3. The package 1 comprises two sheets 30, 30, and the oxygen absorbing tape 10. The sheets 30, 30 are overlaid on each other with one shorter edge of each sheet defining an opening section 20, and the remaining three edge sections form a heat-sealed section 21. The oxygen absorbing tape 10 is adhered to an internal surface of the package 1 in parallel to the opening section 20 at a position close to the shorter edge side in the opposite side from the opening section 20.

As the configuration of the sheet 30, polyethylene telephthalate/aluminum/nylon/polyolefin based resin are employed in this embodiment. As other allowable configurations, there can be enlisted polyethylene telephthalate/nylon/ethylene-vinyl alcohol copolymer/polyolefin-based resin, a layer prepared by vapor-depositing an inorganic material such as silicon oxide or aluminum oxide on polyethylene telephthalate/polyolefin-based resin, polypropylene/ethylene-vinyl alcohol copolymer/polypropylene, nylon/polyolefin-based resin, and as the polyolefin-based resin, for instance, polyethylene or polypropylene can be enlisted.

Further, as the configuration of the layer of the sheet 30 having a gas barrier characteristics, aluminum, nylon, ethylene-vinyl alcohol copolymer and the like or a layer prepared by vapor-depositing an inorganic material such as silicon oxide or aluminum oxide on polyethylene telephthalate can be enlisted.

[4] Method of Manufacturing the Package

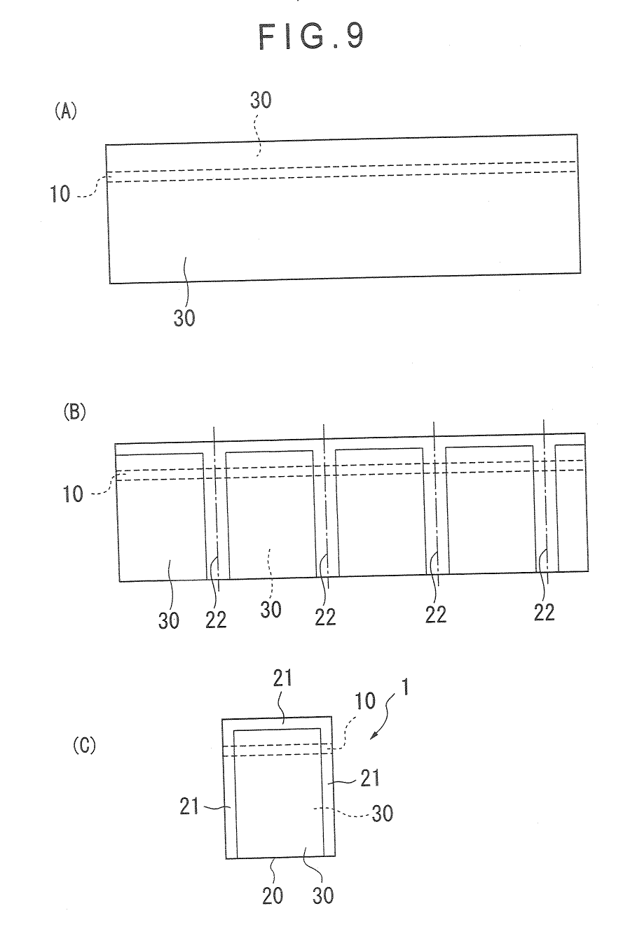

A method of manufacturing the package 1 is described below with REFERENCE to FIG. 9.

Two sheets 30 are continuously fed to a bag-making machine (not shown), and at the same time also the oxygen absorbing tape 10 is fed to the bag-making machine. The oxygen absorbing tape 10 is cut in the same length as that of the short edge of the package 1 to be processed in a bag, and then adhered to a sheet 30 along the longitudinal direction of the sheet 30 and also with the edge of the oxygen absorbing tape 10 reaching to the peripheral section of the sheet 30, with a heating roll (not shown) incorporated in the bag-making machine (tape adhering step, FIG. 9(A)).

Another sheet 30 is overlaid on the sheet 30 with the oxygen absorbing tape 10 having been adhered thereto from the top of the oxygen absorbing tape 10, and the sheet 30 is divided with the length equal to a shorter edge of the package 1 in the direction perpendicular to the longitudinal direction of the sheet 30 to form a partitioned section 22. Then, heat sealing is performed continuously following the three edges of squared U shape including this partitioned section 22 and the short edge opposite to the short edge forming the opening section 20 of the package 1 (sheet adhering step, FIG. 9(B)).

Then sheets 30, 30 heat-sealed continuously following the form of squared U shape are cut along a central line of the partitioned section 22 (sheet cutting step, FIG. 9(C)).

With the embodiment as described above, the following effects are provided.

(1) As the oxygen absorbing tape 10 comprising the oxygen absorbing layer 10A and the thermoplastic resin 10B is attached to inside of the tape 30 with the thermoplastic resin 10B directed to the internal surface of the package 1, different from the case where a sheet having an oxygen absorbing layer 10A for a package 1 is manufactured as a package 1, the oxygen absorbing tape 10 is only adhered to inside of the package 1, so that the capability of oxygen absorbing can easily be given to the package 1.

With the embodiment as described above, the following effects are provided.

(2) As the oxygen absorbing tape 10 comprising the oxygen absorbing layer 10A and the thermoplastic resin 10B has a cross section where the oxygen absorbing layer 10A is coated with the thermoplastic resin 10B, different from the case where a sheet having an oxygen absorbing layer itself is manufactured as a package 1, the oxygen absorbing tape 10 is only thermally adhered to inside of the package 1, so that the manufacturing process is very simple and the production cost is low, and further the capability of oxygen absorbing can easily be given to the package 1.

(3) As the oxygen absorbing layer 10A has a cross section coated with the thermoplastic resin 10B, the contact between the contents and the oxygen absorbing material can be prevented without fail.

(4) As the oxygen absorbing layer 10 is thermally adhered to the sheet 30 to form the inside of the package 1, different from the case in which the tape is adhered to the sheet with adhesive or the like, odor is not generated, so that the odor is not transferred to the contents. Further the heat resistance is improved, so that the tape may be applied for packaging foods to be boiled or pouch-packed foods. Also as the adhesion of the oxygen absorbing tape 10 can be concurrently performed with the thermal adhesion of the edges of sheet 30, the manufacturing process is very efficient.

(5) As the oxygen absorbing tape 10 is adhered to a sheet 30, crossing the two sides which are facing each other and perpendicular to the opening section 20, the oxygen absorbing tape 10 is adhered without mal-distribution, so that the oxygen can be absorbed evenly.

(6) As there is the sheet cutting step, the sheets are cut along the partitioned section 22, so that the positional displacement of a peripheral section of the package 1 never occurs.

(7) As the oxygen absorbing tape 10 is adhered to the sheet 30 with the edge of the oxygen absorbing tape 10 reaching to the peripheral section of sheet 30, the cross section at the edge of the oxygen absorbing tape is adhered to the peripheral section without being exposed to the internal of the package 1, the contact between the contents and the oxygen absorbing material can be prevented without fail.

### Fifth Embodiment

A fifth embodiment of the present invention is described below.

It is to be noted that the same reference numerals are assigned to the same sections and members as those already described above, and detailed description thereof are omitted herefrom.

[3] Package 2

In the package 1, portions of the heat-sealed section 21 and the oxygen absorbing tape 10 overlaid on each other are only heat-sealed, but the package 2 is different the package 1 in the points that ultrasonic sealing is carried out before heat sealing and there is provided a ultrasonically sealed section 23.

[4] Method of Manufacturing the Package 2

The method of manufacturing the package 2 is described below with reference to FIG. 5.

Two sheets 30 are successively fed to a bag-making machine (not shown), and also the oxygen absorbing tape 10 is fed to the bag-making machine. The oxygen absorbing tape 10 is fused with the same length as that of the sheet 30 to the sheet 30 by a heating roller incorporated in the bag-making machine so that the tape 10 is in parallel to the longitudinal direction of the sheet 30 and an edge of the oxygen absorbing tape 10 reaches a peripheral edge section of the sheet 30 (tape adhering step, FIG. 5(A)).

Another sheet 30 is overlaid on the sheet 30 with the oxygen absorbing tape 10 having been adhered thereto from above the oxygen absorbing tape 10. The overlaid portions of the oxygen absorbing tape 10 and the sheets 30 with the length of the opening section 20 of the package 2 are fused to each other by means of ultrasonic heat-sealing with the oxygen absorbing tape 10 therebetween to form a ultrasonically sealed section 23. Then, the ultrasonically sealed section 23 is partitioned to pieces each having the same length as that of a shorter edge of the package 1 in the direction perpendicular to the longitudinal direction of the sheet 30 to form a partitioned section 22. including the ultrasonically sealed section 23. Then, heat sealing is continuously carried out along three edges forming a squared U shape including a shorter edge opposite to that forming the opening section 20 o the package 1 (seat adhering section, FIG. 5(A), (B)).

The sheets 30, 30 continuously heat-sealed and forming the squared U shape is cut along a central line of the portioned section 22 (sheet cutting step, FIG. 5 (C)).

With the embodiment as described above, the following effects are provided in addition to those obtained in the fourth embodiment described above.

(8) In the sheet adhering section, in the portioned section 22, the oxygen absorbing tape 10 is provided between the sheets 30 and are ultrasonically sealed thereto, and because of this configuration, the sheets 30 are adhered to the oxygen absorbing tape 10 on both the top and bottom surfaces thereof, so that the oxygen absorbing tape can tightly be fixed to the package 2.

### Sixth Embodiment

The sixth embodiment of the present invention is described below.

It is to be noted that the same reference numerals are assigned to the same portions and members as those already described above and detailed descriptions thereof are omitted herefrom.

[3] Packaging Container 3

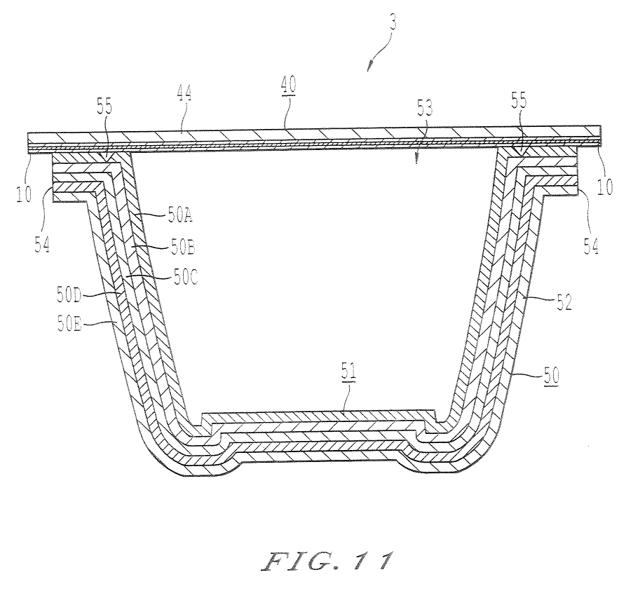

The packaging container 3 comprises a cover member 40 and a molded container 50 as shown in FIG. 11. The circular cover member 40 functions as a cover for the packaging container 3 with the circular peripheral portion adhered to the molded container 50, and comprises a base material sheet 41 and the oxygen absorbing tape 10 adhered to the entire rear surface of the base material sheet 41. The oxygen absorbing tape 10 is adhered to the circular rear surface of the base material sheet 41.

The molded container 50 comprises a side face section 52 standing upright from a periphery of a circular bottom surface of a bottom surface section 51, an opening section 53 formed at the upper edge surrounded by this side face section 52, and a flange section 54 extending outward from the periphery of this opening section 53.

The side face section 52 has a tapered form tapering from the opening section 53 to the bottom surface section 51, and a notch 55 extending along the entire periphery of the opening section 53 is formed in the side of the opening section 53 of the flange section 54.

The molded container 50 has a 5-layer structure comprising a surface layer 50A, a fissile layer 50B, a base material layer 50C, a gas barrier layer 50D, and a base material layer 50E, and of these four layers, a notch having a V-shaped cross section is provided only on the surface layer 50A of the flange section 54 to form the notch 55. In the multi-layered sheet, the gas barrier layer 50D is made of an ethylene-vinyl alcohol copolymer, and other layers are made of polypropylene.

[4] Method of Manufacturing the Packaging Container

The method of manufacturing the packaging container 3 is described below with reference to FIG. 9. The oxygen absorbing tape 10 is thermally adhered by a heating roller to a rear surface of the base material sheet 41 cut into a circular form with a doughnut form corresponding to the circular periphery portion thereof to form the cover member 40. A position of the cover member 40 is adjusted so that the oxygen absorbing tape corresponds to the flange section 54 of the molded container 50.

With the embodiment of the present invention as described above, the following effects are provided in addition to those obtained in each of the embodiments described above.

(9) The cover member 40 is adhered to the molded container 50 with the oxygen absorbing tape 10 therebetween, and when the cover member 40 is separated, also the cover member 40 is separated together with the surface layer 50A, so that the cover member 40 can be separated from the molded container 50 without exposing the oxygen absorbing layer 10A, and therefore the contents is never contacted to the oxygen absorbing material.

In the embodiments described above, the oxygen absorbing tape 10 is adhered to an area near a surface opposite to an opening section of a package or on a rear surface of a cover member for a packaging container, but the present invention is not limited to these cases, and the oxygen absorbing tape can be adhered to any area such as an intermediate area of an opening of a package, and further may be adhered to any portions including the entire surface of the packaging container, a central portion of the cover member, and an internal surface of the packaging container.

It is to be noted that, in the fourth to sixth embodiments described above, also the variants as described below are encompassed in a scope of the present invention.

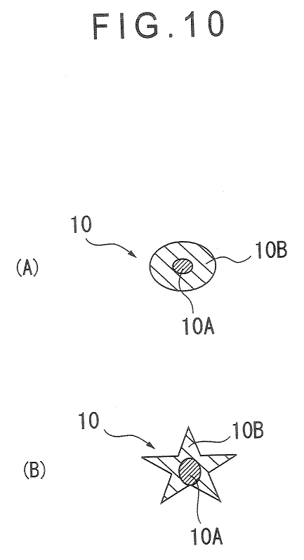

For instance, as for a form of a cross section of the oxygen absorbing tape 10, a rectangular cross-section of the oxygen absorbing layer 10A is completely covered with the thermoplastic layer 10B in each of the embodiments described above (Refer to FIG. 1), but the present invention is not limited to this case, and various forms are allowable including a form in which a section around the circular oxygen absorbing layer 10A is covered with the thermoplastic resin layer 10B having a doughnut-like form (FIG. 10(A)), or a form in which a section around the circular oxygen absorbing layer 10A is covered with the star-shaped thermoplastic resin layer 10B (Refer to FIG. 10(B)).

The multilayer different form extrusion method was employed as a method of manufacturing the oxygen absorbing tape 10 in each of the embodiments described above, but the present invention is not limited to this case, and various methods may be employed including a method in which an oxygen absorbing material is filled in a thermoplastic resin tube and is thermally applied by a heating roller or the like, a method in which an oxygen absorbing material is filled between unwoven clothes or woven clothes made from a thermoplastic resin and is coated with the thermoplastic resin sheet or the like and is thermally applied thereto, and a method in which the oxygen absorbing material is inserted into a thermoplastic resin tube.

As for a form of the package 1 or package 2, a three-side sealed bag was employed in each of the embodiments described above, but the present invention is not limited to this case, and various bag forms such as a portrait type pillow bag, a landscape type pillow bag, a bag sealed along four edges, a gazette bag, a self-sustaining bag, and the like.

The oxygen absorbing tape 10 is adhered to an area near a surface opposite to an opening section of a package, but the present invention is not limited to this case, and the oxygen absorbing tape 10 may be adhered to any section such an intermediate portion of the opening section of the package.

Other various structures and forms may be employed for carrying out the present invention within a range in which the objects of the present invention are achieved.

The present invention is described in more details below with reference to examples and comparative examples thereof. It is to be noted that the present invention is not limited to the contents of the examples described below.

### EXAMPLE 10

The present invention is described in more details below with reference to examples and comparative examples thereof.

In the fourth embodiment, the oxygen absorbing tape 10 was manufactured under the following conditions.

The screw diameters of a single-spindle extruder in the multilayer different form device were 30 mmΦ and 40 mmΦ.

Oxygen absorbing layer 10A: Master batch with the mixing ratio of polypropylene (Idemitsu polypro E-170 GM) and iron powder-based oxygen absorbing agent (comprising iron powder with the bulk specific weight of 2.0 or more and the specific surface area of 0.5 or more and salt) of 60:40.

Thermoplastic resin layer 10B: Polypropylene (Idemitsu polypro E-170 GM)

The production rate is 25 m/min (discharge rate: 13 kg/hour), and loss of the oxygen absorbing tape 10 before the production process was stabilized was about 100 m (about 1 kg). Further the thickness of each layer of the oxygen absorbing tape 10 is as shown below.

Thickness T₁ of the oxygen absorbing tape 10: 300 μm

Width W₁ of the oxygen absorbing tape: 30 mm

Thickness T₂ of the oxygen absorbing layer 10A: 200 μm

Thickness T₃ of the thermoplastic layer 10B: 50 μm

In the fourth embodiment, the package 1 was manufactured under the following conditions.

Configuration of the sheet 30: Polyethylene telephthalate/aluminum/nylon/Not-drawn polypropylene (Thickness: 12 μm/7 μm/15μm/60 μm)

The two sheets 30 were adhered to each other overlaying the not-drawing polypropylene layers.

### EXAMPLE 11

The oxygen absorbing tape 10 was manufactured like in Example 10.

In the fifth embodiment of the present invention, the package 2 was manufactured under the following conditions.

Configuration of the sheet 30: Polyethylene telephthalate/aluminum/nylon/not-drawn polypropylene (Thickness: 12 μm/7 μm/15 μm/60 μm)

The two sheets 30 were adhered to each other overlaying the not-drawing polypropylene layers.

Ultrasonic sealing was carried out with a ultrasonic phone with a tip having the dimensions of 35 mm×20 mm.

### EXAMPLE 12

The oxygen absorbing tape 10 was manufactured like in Example 10.

In the fourth embodiment, the package 2 was manufactured under the following conditions.

Configuration of the sheet 30: Nylon/ethylene-vinyl alcohol copolymer/nylon/not-drawn polypropylene (Thickness: 12 μm/7 μm/15 μm/60 μm)

Oxygen permeability of the sheet 30 (20° C., 80% RH): 1 ml/m²/atm/day (Measurement method ASTM D1434)

The two sheets 30 were adhered to each other overlaying the not-drawing polypropylene layers.

### EXAMPLE 13

The oxygen absorbing tape 10 was manufactured like in Example 10.

In the sixth embodiment, the package 3 was manufactured under the following conditions.

Configuration of the base material sheet 41 of the cover member 40: Polyethylene telephthalate/aluminum/nylon/not-drawn polypropylene (Thickness: 12 μm/7 μm/15 μm/60 μm)

Configuration of the molded container 50: Surface layer 50A: Polypropylene/Fissile layer 50B: polypropylene: polyethylene=8:2/Base material layer 50C: polypropylene/Gas barrier layer 50D: ethylene-vinyl alcohol copolymer/Base material layer 50E: polypropylene (Thickness: 10 μm/30 μm/395 μm/70 μm/395 μm)

It is to be noted that an adhesion force between the surface layer 50A and the intermediate layer 50B is weaker than that between the surface layer 50A and the oxygen absorbing tape 10.

The molded container 50 was manufactured by molding and curing Sheet Magic Top SEP grade produced by Idemitsu Unitech Co., ltd., having the configuration as described above. The molded container 50 had the aperture diameter of 80 mmΦ, depth of 30 mm, and capacity of 80 ml.

The opening strength of the packaging container was 1.2 kg/15 mm, which indicated the excellent separability.

### COMPARATIVE EXAMPLE 11

A bilayer oxygen absorbing sheet (thickness: 80 μm, and width: 600 mm) comprising an oxygen absorbing layer (thickness: 50 μm), and an external layer (thickness: 30 μm) was manufactured with the co-extrusion multilayered sheet extrusion device comprising two units of single-spindle extruders.

The screw diameters of the co-extrusion multilayered sheet extrusion device were 50 mmΦ and 60 mmΦ respectively.

Oxygen absorbing layer: Master batch comprising polypropylene (Idemitsu polypro E-170GM) and ion powder-based oxygen absorbing agent (comprising iron powder with the bulk specific weight of 2.0 or more and the specific surface area of 0.5 or more and salt or the like) with the mixing ratio of 70:30

External layer: Polypropylene (Idemitsu polypro E-170GM)

The production rate was 3.7 m/min (discharge rate: 13 kg/hour), and surface conditions of the oxygen absorbing sheet were adjusted with also the thickness adjusted, and the loss before the production process was stabilized was about 20 kg. Also the ear loss of about 20% by weight was always generated during the production.

The oxygen absorbing sheet completed as described above was subjected to dry laminating so that the nylon surface of the three-layered structure comprising polyethylene telephthalate/aluminum/nylon (thickness: 12 μm/7 μm/15 μm) previously prepared by dry-laminating was overlaid on the oxygen absorbing layer. The ear loss of 5% by weight was generated during this dry laminating step.

The obtained five-layered sheet comprising polyethylene/aluminum/nylon/oxygen absorbing layer/polypropylene (thickness: 12 μm/7 μm/15 μm/50 μm/30 μm) was heat-sealed by the bag-making machine used in the fourth embodiment by sealing the three edges forming a squared U shape to obtain a package with the outer dimensions of 200 mm×140 mm.

### COMPARATIVE EXAMPLE 12

The oxygen absorbing tape (thickness: 300 μm, width: 30 mm) was manufactured like in Example 10. Although, in a cross section of the oxygen absorbing tape 10, the rectangular oxygen absorbing layer 10A was covered with the thermoplastic resin layer 10B in Example 10, the oxygen absorbing tape 10 obtained in Comparative Example 12 was different from that obtained in Example 10 only in the point that it has only the sandwich-type three-layered structure comprising an outer layer (thickness: 50 μm), an oxygen absorbing layer (thickness: 200 μm), and an outer layer (thickness: 50 μm).

The production rate was 25 m/min (discharge rate: 13 kg/hour), and loss of the oxygen absorbing tape 10 before the production process was stabilized was about 100 m (about 1 kg).

In the fourth embodiment, a package was manufactured under the following conditions:

Configuration of the sheet 30: Polyethylene telephthalate/aluminum/nylon/not-drawn polypropylene (Thickness: 12 μm/7 μm/15 μm/60 μm)

The two sheets 30 were adhered to each other by overlaying the not-drawn polypropylene layers.

### COMPARATIVE EXAMPLE 13

The oxygen absorbing tape was manufactured like in Example 10.

In the sixth embodiment, the packaging container 3 was manufactured under the following conditions:

Configuration of the base material sheet 41 of the cover member 40: Polyethylene telephthalate/aluminum/nylon/not-drawn polypropylene (Thickness: 12 μm/7 μm/15 μm/60 μm)

Configuration of the molded container (three-layered structure): Polyethylene/ethylene-vinyl alcohol copolymer/polypropylene (total thickness: 0.9 mm)

The adhesion force between the polypropylene and the ethylene-vinyl alcohol copolymer is substantially stronger than that between the polypropylene and the oxygen absorbing tape 10.

The opening strength of the molded container was 3.5 kg/15 mm, and when it was tried to forcefully open it, the tape 10 could not be separated from the surface layer, and the packaging container remarkably deformed.

### Assessment of the Performance

100 ml of distilled water and 100 ml of air were put in each of the packaging bodies obtained in Examples 10 to 13 and Comparative Examples 11 to 13 with the openings of the packaging bodies tight-sealed respectively, and then heating was carried out for 30 minutes at 120° C. according to the constant differential pressure system for packing foods in the pouches.

Further 70 ml of distilled water was put in the packaging container obtained in Example 13, and the container was tight-sealed with the cover member, and then heating was carried out for 30 minutes at 120° C. according to the constant differential pressure system for packing foods in the pouches.

The oxygen gas density inside and around the openings of the packaging bodies was measured by means of gas chromatography before the processing for packing foods in the pouches, just after the processing packing foods in the pouches was finished, once for every two hours after the end of the processing packing foods in the pouches in the state where the samples were kept at 20° C., namely in 2 hours, 4 hours, and 6 hours after the end of the processing. Further, sensory tests were conducted for odor of the distilled water kept in each package after each sample was left for one month at the room temperature. The test result is shown in Table 1.

From this Table 1, it is understood that, in the packaging bodies according to the present invention obtained in Examples 10 to 13, the oxygen was more absorbed as compared to those in Comparative Examples 11 and 12, and that the odor of the distilled water kept for one month was not worrying.

TABLE 1

| | | | | | | Result of |
|---|---|---|---|---|---|---|
| | Density of oxygen gas (ml/ml, %) | | | | | odor |
| | Before | Just after | In two | In four | In six | assess- |
| | processing | processing | hours | hours | hours | ment |
| Examples | 21 | 15 | 10 | 5 | 0 | Not |
| 10, 11 | | | | | | worrying |
| Example | 21 | 16 | 11 | 6 | 0 | Not |
| 12 | | | | | | worrying |
| Example | 21 | 13 | 9 | 4 | 0 | Not |
| 13 | | | | | | worrying |
| Com. | 21 | 13 | 10 | 5 | 0 | Worrying |
| Exam. 11 | | | | | | |
| Com. | 21 | 15 | 9 | 4 | 0 | Very |
| Exam. 12 | | | | | | worrying |

### Seventh Embodiment

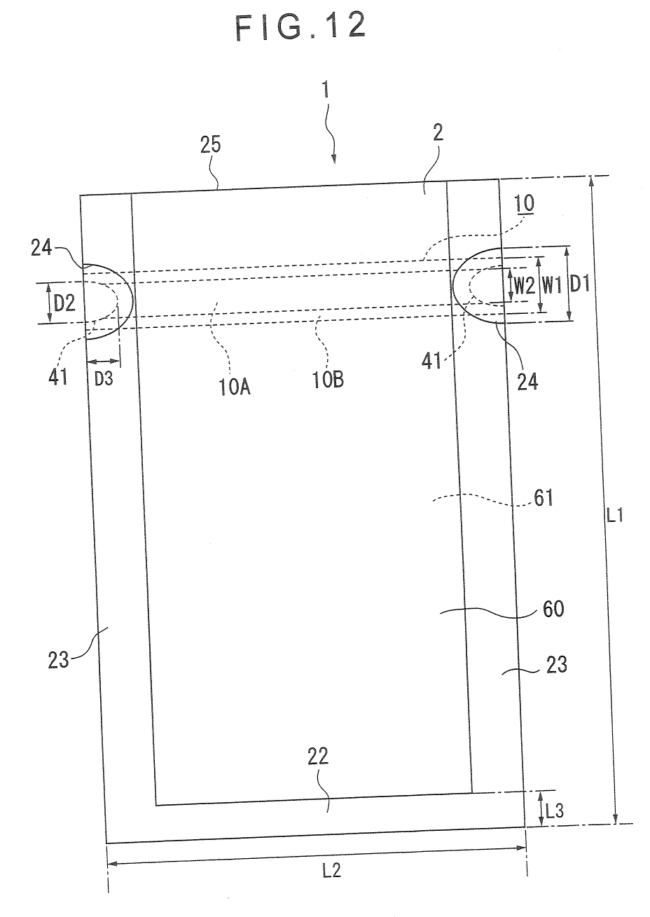

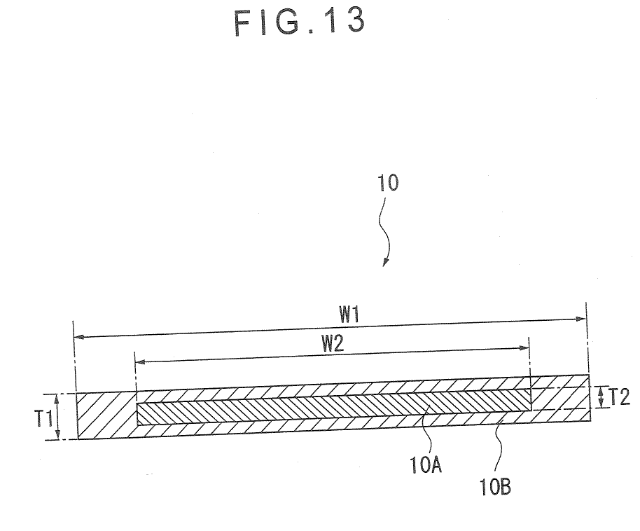

The package 1 with the atmosphere improving tape obtained in the seventh embodiment of the present invention is shown in FIG. 12. FIG. 13 is a cross-sectional view showing the atmosphere improving tape 10.

The package 1 with an atmosphere improving tape comprises a main body 2 of the package for blocking contact of air with the contents, and the atmosphere improving tape 10. The main body 2 of the package is formed by thermally adhering the edge portions of the two sheets 30 overlaid on each other.

Sheets 60, 61 in the main body 2 of the package are laminated sheets each having a three-layered structure of ONY (15 μm), EVOH (12 μm), and LLDPE (60 μm). When the sheets 60 and 61 are thermally adhered to each other, the LLDPE layers of the sheets are thermally adhered to each other.

Shorter edges the sheets 60 and 61 of the main body 2 of the package in the overlaid portion form an opening section 25. Edges of the sheets opposite to the opening section 25 form a heat-sealed section 22 in the bottom side. Two edges of the sheets 60 and 61 perpendicular to the opening 25 form side heat-sealed portions 23 when thermally adhered to each other. In the side heat-sealed sections 23 as well as in the opening section 25, semi-circular ultrasonically sealed sections 24 are formed at opposite positions respectively.

The atmosphere improving tape 10 is thermally adhered to inside of the main body 2 of the package. The atmosphere improving tape 10 is thermally adhered onto an internal surface of the sheet 61 in parallel to the opening section 25. More specifically the atmosphere improving tape 10 comprises, as shown in FIG. 13, the atmosphere improving layer 10A containing an atmosphere improving material therein and the thermoplastic resin layer 10B, and the atmosphere improving layer 10A has a cross section coated with the thermoplastic resin layer 10B.

The atmosphere improving layer 10A is prepared by kneading PS (polystyrene) and an iron powder-based oxygen absorbing agent together. The thermoplastic resin layer 10B is made of LLDPE (linear low density polyethylene). The adhesion force between the atmosphere improving layer 10A and the thermoplastic resin layer 10B is 500 g/15 mm in width.

The adhesion force was measured with a tensile tester at the tensile rate of 200 mm/minute at the separation degree (T-separation) of 180° C. The data indicates an average value obtained in the test with the sample width of 50 mm, chuck space of 50 mm, and N=5.

A substantially semicircular notched section 41 is formed at an edge section of the atmosphere improving tape 10 in its extending direction. The width of an edge face of the notched section 41 is smaller than the width of the atmosphere improving tape 10.

Further the edge section of the atmosphere improving tape 10 in its extending direction is buried in the side heat-sealed sections 23 of the sheets 60, 61 as well as in the ultrasonically sealed section 24.

In the following description, it is assumed that L1 indicates a length of the package 1 with the atmosphere improving tape in the longitudinal direction, L2 indicates the length in the sideward direction, and L3 indicates the width of the heat-sealed section 22 in the bottom section. Further it is assumed in the following description that D1 indicates a length of a diameter portion of the ultrasonically sealed section 24, D2 indicates a length of a diameter portion of the notched section 41, and D3 indicates a length of the notched section 41 in the sideward direction. Further it is assumed in the following description that T1 indicates a thickness of the atmosphere improving tape 10, T2 indicates a thickness of the atmosphere improving layer 10A, W1 indicates a width of the atmosphere improving tape 10, and W2 indicates a width of the atmosphere improving layer 10A. The dimensions may be changed within the range in which the objects of the present invention can be achieved.

In this embodiment, L1 is 200 mm; L2 is 120 mm; L3 is 15 mm; D2 is 17 mm; D3 is 8.5 mm; T1 is 0.2 mm; T2 is 0.1 mm; W1 is 20 mm; and W2 is 15 mm.

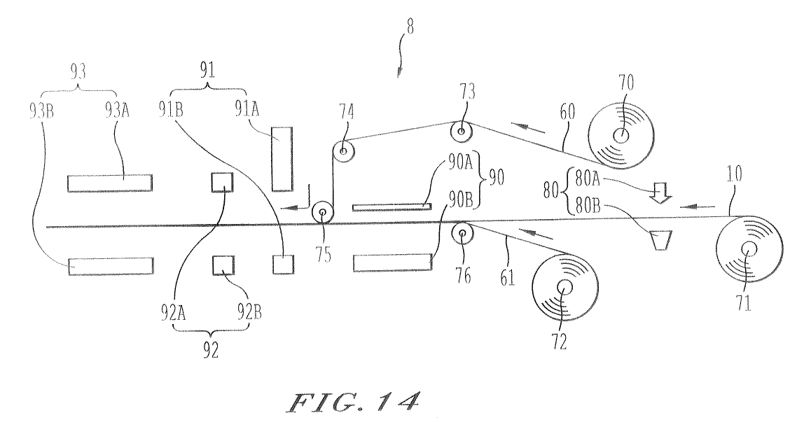

FIG. 14 shows a device 5 for manufacturing the package 1 with an atmosphere improving tape. The manufacturing device 5 comprises wind-up rollers 50, 51, 52; rollers 53, 54, 55, 56; a punching device 40; a tape sealing device 30; ultrasonic sealing device 31; a sideward sealing device 32, and a top-to-bottom sealing device 33.

The sheet 60 is previously wound around and fed out from the wind-up roller 50. The atmosphere improving tape 10 is previously wound around and fed out from the wind-up roller 51. The sheet 61 is previously wound around and fed out from the wind-up roller 52.

The sheets 60 and 61 are required to be wound around the wind-up rollers 50 and 52 so that the highly adhesive surfaces thereof face to each other. In this embodiment, the LLDPE layers of the sheets 60 and 61 face to each other. Any known roller may be used for the wind-up rollers 50, 51, and 52.

The roller 53 is used to support the sheet 60 from the bottom side. The roller 54 is used to support the sheet 60 from the bottom side, and the sheet 60 is hung down from this roller 54. The roller 55 supports the sheet 60 from the top side. This roller 56 supports the sheet 61 and the atmosphere improving tape 10 from the bottom side. Any known roller may be used as the rollers 53, 54, 55, and 56.

The punching device 40 comprises a punch 40A and a punch receiver 40B, and is used to punch the atmosphere improving tape 10. The punch 40A can punch a oval hole. A form and size of a hole punched by the punch 40A can be changed, and other forms of the holes punched by the punch 40A include a circle, a triangle, a square, a pentagon, and other polygonal forms. The punch receiver 40B has a hole having a form and size corresponding to those of the punch 40A, and supports the atmosphere improving tape 10 from the bottom side.

The tape sealing device 30 is used to heat-seal the atmosphere improving tape 10 to the sheet 61. The tape sealing device 30 comprises a seal receiving plate 30A provided in the upper side and a tape sealing bar 30B provided in the lower side.

The sheet receiving plate 30A presses the atmosphere improving tape 10 to the tape sealing bar 30B from the top side. The tape sealing bar 30B has a heating function, and heats the atmosphere improving tape 10 and the sheet 61 for thermally adhering them together.

The ultrasonic sealing device 31 comprises an ultrasonic horn section 31A and an anvil 31B, and adheres objects by making use of a heat locally generated by ultrasonic vibrations. The ultrasonic sealing device 31 adheres the sheets 60 and 61 so that the areas around the holes on the atmosphere improving tape 10 formed by the punching device 40 are covered with each other.

The ultrasonic phone section 31 A generates ultrasonic vibrations. A diameter of the ultrasonic phone section 31A is 25 mm. The anvil 31B has a base of a truncated cone. The anvil 31B has a large bottom surface to endure physical shock or load, and can load a pressure in the axial direction to a small top surface.

The sideward sealing device 32 comprises sideward sealing bars 32A, 32B (each with the width of 25 mm). The sideward sealing bars 32A, 32B are used to heat-seal the sheet 60, atmosphere improving tape 10, and sheet 61 overlaid on each other for forming the side heat-sealed section 23 of the package 1 with the atmosphere improving tape. Both of the sideward sealing devices 32 have a heating function respectively and thermally adhere the sheet 60, atmosphere improving tape 10, and sheet 61 to each other.

The top-to-bottom sealing device 33 comprises top-to-bottom sealing bars 33A, 33B (with the thickness of 15 mm). The top-to-bottom sealing device 33 heat-seals the sheet 60 and sheet 61 overlaid on each other to form a top-to-bottom heat-sealed section 22 of the package 1 with an atmosphere improving tape. Both of the top-to-bottom sealing bars 33A and 33B have a heating function respectively for thermally adhering the sheet 60 and sheet 61 to each other.

At first, a method of manufacturing the atmosphere improving tape 10 is described below. The atmosphere improving tape 10 is manufactured by subjecting the materials constituting the atmosphere improving layer 10A and the thermoplastic resin layer 10B to multilayer different form extrusion with a multilayer different form extrusion device comprising two units of single-spindle extruders not shown. With the multilayer different form extrusion device, the atmosphere improving tape 10 having a cross section as shown in FIG. 13 is formed. Both of the single-spindle extruders of the multilayer different form extrusion device have the screw diameter of 30 mmΦ. The atmosphere improving tape 10 is solidified with water.

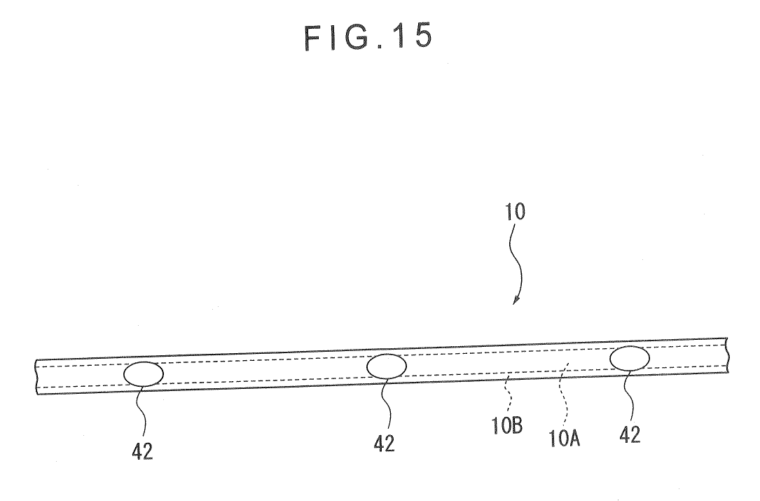

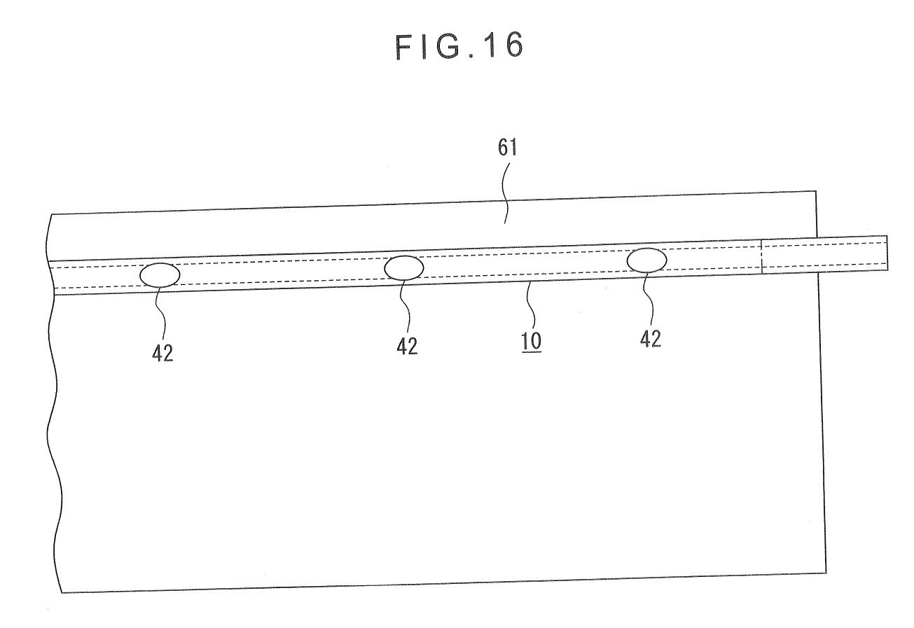

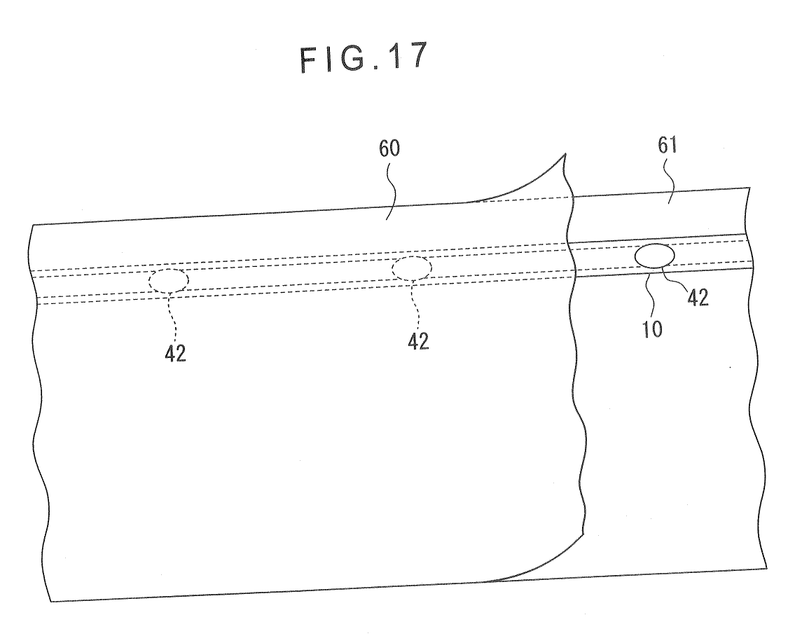

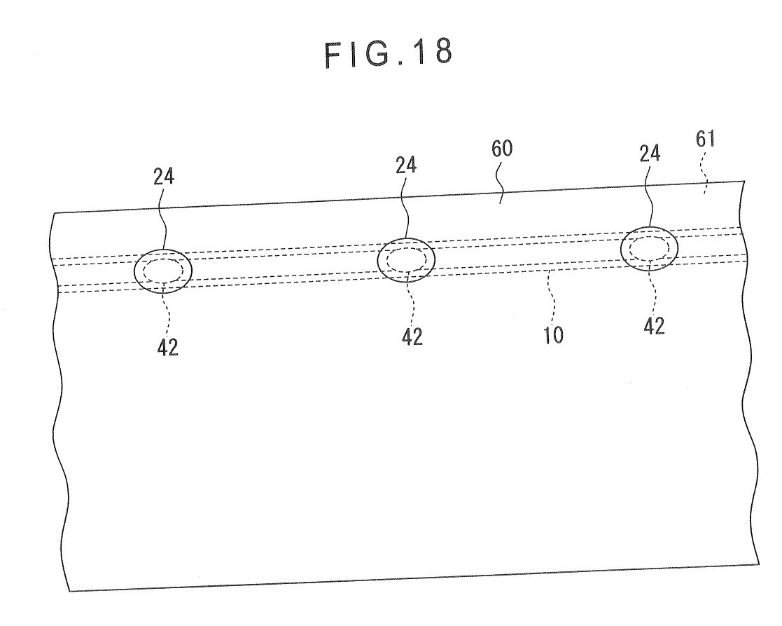

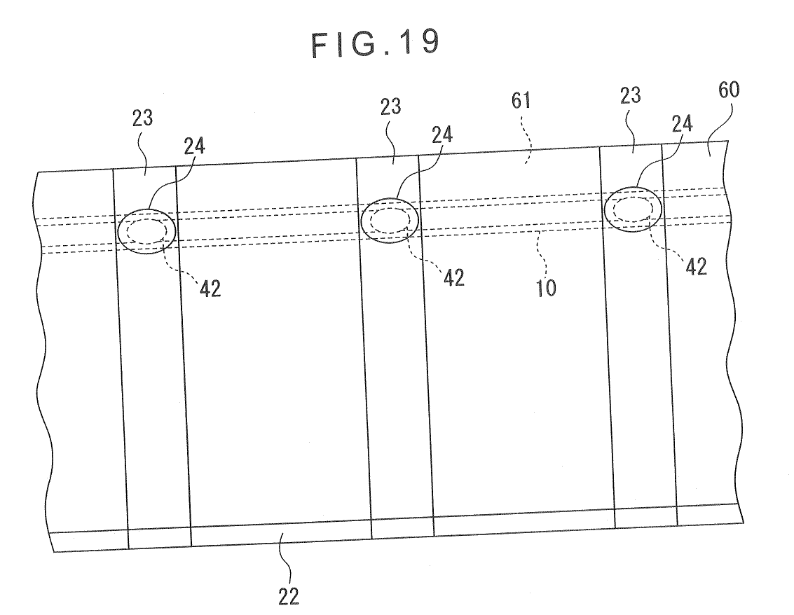

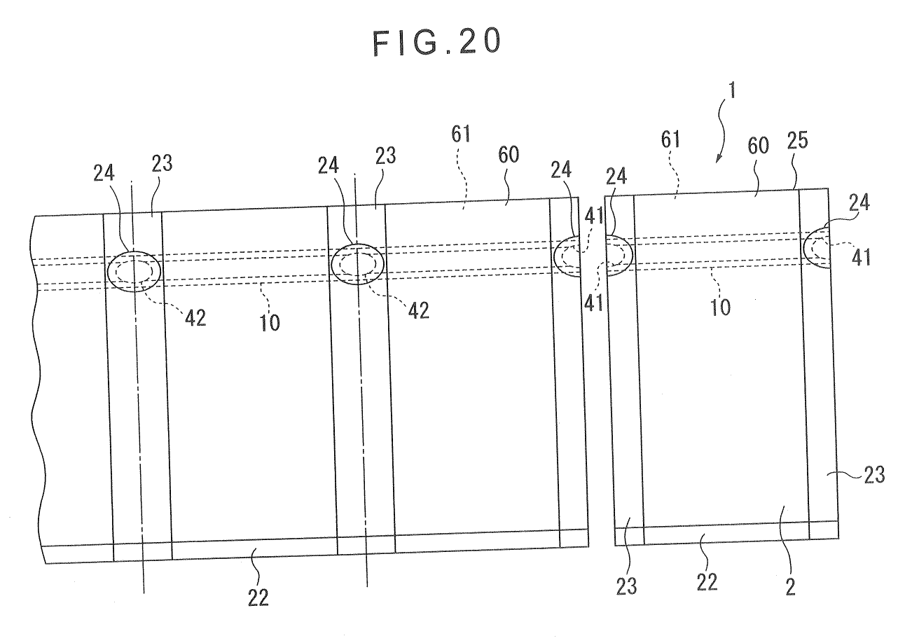

Then a method of manufacturing the package 1 with an atmosphere improving tape using the manufacturing device 5 shown in FIG. 14. FIG. 15 is a view showing a step of forming a notch on the atmosphere improving tape 10 with the punching device 40. FIG. 16 is a view showing a tape adhering step of the atmosphere improving tape 10 with the tape sealing device 30. FIG. 17 is a view showing the state where the sheets have been overlaid on each other after the tape adhering step. FIG. 18 is a view showing an ultrasonically sealing step with the ultrasonic sealing device 31. FIG. 19 is a view showing a sheet adhering step with the sideward sealing device 32 and the top-to-bottom sealing device 33. FIG. 20 is a view showing a sheet cutting step of cutting a sheet along a central portion of the side heat-sealed section 23.

At first, as shown in FIG. 15, the notched holes 42 are formed with the punching device 40 at a central portion of the atmosphere improving tape 10 with an even space therebetween. The size of this notched hole 42 in the sideward direction of the atmosphere improving tape 10 is larger than the sideward size of the atmosphere improving layer 10A, but is smaller than the width of the atmosphere improving tape 10. This notched hole 42 has an oval form with the sideward axis longer than the top-to-bottom axis (notch forming step). In this embodiment, the notched holes 42 each having the diameter of about 17 mmΦ is formed by the punching device 40 with a space of 120 mm.

Then, as shown in FIG. 16, the atmosphere improving tape 10 is heat-sealed on the top of the sheet 61 with the tape sealing device 30. This heat sealing is performed in the state where a seal receiving plate 30A (Refer to FIG. 14) presses the atmosphere improving tape 10 to the tape sealing bar 30B from the top side, and heating the sheet 61 with the tape sealing bar 30B (Refer to FIG. 14) from the bottom side (tape adhering step). Further another sheet 60 is overlaid on the sheet 61 with the atmosphere improving tape 10 having been adhered thereon as shown in FIG. 17 (the portion corresponding to the roller 55 in FIG. 14).

Then, as shown in FIG. 18, with the ultrasonic sealing device 31, the ultrasonically sealed section 24 (with the diameter of 25 mm) is formed in the state where it covers an area around the notched hole 42 on the atmosphere improving tape 10. This ultrasonically sealed section 24 is larger than the notched hole 42. In the ultrasonically sealed section 24, the sheets 60 and 61 are overlaid on each other with the atmosphere improving tape 10 therebetween (ultrasonic sealing step).

Then as shown in FIG. 19, with the sideward sealing device 32, the sheet 60, atmosphere improving tape 10, and sheet 61 are thermally adhered to each other along a direction perpendicular to the longitudinal direction of the sheets 60, 61 to form the side seat-sealed section 23 (with the side of 25 mm) with an even space.

Further, with the top-to-bottom sealing device 33, the edges of the sheets 60, 61 further from the section to which the atmosphere improving tape 10 has been thermally adhered is thermally adhered to each other in the horizontal direction against the longitudinal direction thereof to form the top-to-bottom heat-sealed section 22 (with the width of 15 mm) (sheet adhering step).

Finally, as shown in FIG. 20, the sheet 60, atmosphere improving tape 10, and sheets 61 overlaid on each other is cut along a central portion of the side heat-sealed section 23 in the sideward direction and also a central portion of the notched hole 42 (sheet cutting step). With this sheet cutting step, the notched hole 42 is divided to two semi-circles to form the notched section 41. In actual use, a material to be packaged is put therein from the opening section 25, and then the opening section 25 is closed by heat sealing or the like.

With the embodiment as described above, the following effects are provided.

(1) As the atmosphere improving tape 10 is adhered on an internal surface of the sheet 61 and therefore the atmosphere improving capability is given to the tape with a narrow width, and therefore, different from the conventional technology, the problem never occurs that the fluidity of a resin can not be adjusted to a desired level for molding the resin into a large film form. Therefore, there are few restriction over selection of the atmosphere improving materials, and many types of atmosphere improving materials may be employed in this invention.

(2) As the atmosphere improving layer 10A has a cross section coated with the thermoplastic resin layer 10B, so that an adhesive for adhering the atmosphere improving layer 10A to the thermoplastic resin layer 10B to each other is not required. Therefore there is no need of taking into consideration a combination of an adhesive and an atmosphere improving material, so that there is no restriction in selecting the atmosphere improving material.

(3) The edge section of the atmosphere improving tape in its extending direction is buried in the side heat-sealed sections of the sheets 60, 61 as well as in the ultrasonically sealed section 24, so that the atmosphere improving layer 10A is never exposed to outside of the package 1 with the atmosphere improving tape. For the reason as described above, iron powder or the like as the atmosphere improving material never leaks from the atmosphere improving layer 10A, so that contamination never occurs around the package 1 with an atmosphere improving tape.

(4) As the notched section 41 is formed after the notched hole 42 is formed, the edge section of the atmosphere improving tape 10 in its extending direction is notched more as it gets closer to a central portion of the atmosphere improving tape 10 in the sideward direction. Herein, the atmosphere improving layer 10A is formed at a substantially central portion of the atmosphere improving tape 10 in the sideward direction. Therefore the distance from the edge section of the atmosphere improving tape 10 in its extending direction to the atmosphere improving layer 10A is relatively large, so a quantity of an atmosphere improving material leaked from the atmosphere improving layer 10A can further be reduced. Further an area where the sheets 60, 61 are thermally adhered to each other in the side heat-sealed section 23 is large, so that the adhesion force of the side heat-sealed section 23 can be improved, and leakage of the contents can be prevented without fail.

(5) The side heat-sealed section 23 in which the sheets 60 and 61 are thermally adhered to each other is cut along a line dividing the notched hole 42, so that an edge face of the notched hole 42 of the atmosphere improving tape is relatively large from edge face portions of the cut sheets 60, 21. Namely, the edge section of the atmosphere improving tape 10 in its extending section is buried in the side heat-sealed sections 23 of the sheets 60, 61, so that the atmosphere improving layer 10A is never exposed to outside of the package 1 with an atmosphere improving tape. For this reason, such a trouble as leakage of the atmosphere improving material from the atmosphere improving tape 10A never occurs, and for the reasons as described above, it is possible to manufacture the package 1 with an atmosphere improving tape never contaminating an area around the package 1.

The present invention is not limited to the embodiments described above, and changes or modifications in the range in which the objects of the present invention can be achieved are encompassed within the scope of the present invention.

For instance, the laminated sheet of ONY/EVOH/LLDPE is employed as a material for the sheets 60, 61, but the present invention is not limited to this configuration, and other types of laminated sheets such as PET/CPP (not-drawn polypropylene), PET/LLDPE (linear low density polyethylene), PET/LDPE (low density polyethylene), ONY/CPP, ONY/LLDPE, ONY/LDPE, PET/ONY/CPP, PET/ONY/LLDPE, PET/ONY/LDPE or the like may be used in the present invention.

As the laminated sheets, there can be enlisted such multilayered sheets as PP/EVOH/PP, or PS (polystyrene)/EVOH/PE or the like.

In addition, such multilayered sheets as ceramics-deposited PET/ONY/PO (polyolefin-based resin), PE/ONY/AL(Aluminum)/PO or the like can be enlisted. The polyolefin resins available in these cases include CPP, LLDP, and LDPE.

Further, in addition to the PO (polyolefin-based resins) described above, also materials which can easily be adhered thermally or can easily be separated may be used as raw materials for preparing the sheets 60, 61. There can be enlisted, as the available materials, EVA (ethylene vinyl acetate), polyolefin-based resins with SBS (styrene-butadiene-styrene) rubber or EPR (ethylene-propylene rubber) or the like kneaded therein, a mixture of PP (polypropylene) and PE (polyethylene).

A monolayer sheet may be used as the sheets 60, 61. For instance, sheets made from such materials as PS, PP, and PE may be used. As the PE, such materials as LLDPE and LDPE can be enlisted.

In the embodiments described above, the atmosphere improving layer 10A of the atmosphere improving tape 10 comprises PS (polystyrene) and an iron powder-based oxidizing agent kneaded with each other, but the material available for this purpose is not limited to this case, and any configuration is allowable on the condition that an atmosphere improving material is contained therein, and for instance, a thermoplastic resin originally containing an atmosphere improving material or a thermoplastic resin with an atmosphere improving material kneaded therein may be used for this purpose.

As the thermoplastic resins originally containing an atmosphere improving material, there can be enlisted a nanocomposite nylon resin having the oxygen absorbing capability, polyester with butane diol branched in the molecule or the like may be enlisted.

In the configuration in which an atmosphere improving material is kneaded in a thermoplastic resin, as the thermoplastic resin, such polyolefin-based resins, for instance, PP, PE or the like can be enlisted. As the PE available for this purpose, for instance, LLDPE, LDPE can be enlisted, and CCP or the like can be enlisted as the PP. Further a material which can easily be adhered thermally or can easily be separated may be added in the polyolefin-based rein or PS described above. As the additives, for instance, there can be enlisted such materials as EVA (ethylene vinyl acetate), polyolefin-based resins with such as rubber as SBS (styrene-bitadiene-styrene) rubber or EPR (thylene-propylene rubber) kneaded therein, a mixture of PP (polypropylene) and PE (polyethylene) or the like.

As the atmosphere improving materials available for this purpose, in addition to an oxygen absorbing agent, there can be enlisted such materials as a volatile antibiotic agent, a drying agent, a volatile antitick agent, a volatile insect repellent, a deodorizer, a volatile antirust agent, and a volatile animal repelling agent.

As the oxygen absorbing agents available for this purpose, in addition to iron, there can be enlisted such materials as, for instance, metallic powder of such metals as iron and zinc, oxides with low reducing capability of iron such as FeO, FeTiO₂, and Fe₂O₃, organic metal complexes, compound of transitional metals, ascorbic acid, phenol-based substances, sulfite salt, hydrogen sulfite, tiosulfate salt, oxalates, pyrogallol, catechol, longalit, vitamin C, nanocomposite nylon resin, polyester with butane diol branched in the molecule, glucose, or the like.

As the volatile antibiotic agents available for this purpose, there can be enlisted such materials as isocyanic acid compounds, Japanese cypress thiol, oil extracted from bamboo, oil extracted from beefsteak plant, and thiazolyl sulfamide compounds.

As the drying agents available for this purpose, there can be enlisted such materials a, for instance, calcium oxide, an alumina drying agent, silica gel, magnesium salt, and zeolite.

As the volatile preservatives against mold available for this purpose, there can be enlisted such materials as organic tin compounds, organic sulfur compounds, chlorine-based compounds, phenol-based compounds, and thymol.

As the volatile antitick agents available for this purpose, there can be enlisted such materials as allethrin, tetramethrin, lesmethrin, phenotoframethrin, permethrin, diphenothrin, tralomethrin, empenthrin, DDVP, fenithion, temephos, diflubenzron, buprofedin, pyriproxiphen, and mentha oil.

As the volatile insect repellants available for this purpose, there can be enlisted such materials as cresol, O-phenyl phenol, parathion, and imidazole.

As the deodorants available for this purpose, there can be enlisted such materials as silica gel, active alumina, titanium oxide, zinc oxide, carbon black, and zeolite.

As the volatile antirust agents available for this purpose, there can be enlisted such materials as biannulate benzoazole compounds, monoannulate imidazole, triazole, rosin, diisopropyl nitrite ammonium, benzoic acid, cabrylic acid, dicyclohexil nitrite ammonium, dicyclo carbonate ammonium, and nitrite.

As the volatile animal-repelling agents available for this purpose, there can be enlisted such materials as pyrethrin, rotenone, phthalthrin, allethrin, permetrin, cybermethrin, alpha cybermethrin, phenothrin, diphenothrin, menthol, Japanese cypress oil, Japanese cedar oil, Hiba oil, dithiocarbamoryl sulfide compounds, cynnamic aldehide, and linalool oil.

In the embodiments described above, the thermoplastic resin layer 10B is made of LLDPE (linear low density polyethylene), but the present invention is not limited to this case, and a layer comprising a polyolefin-based resin such as PP and PE, or PS may be used for this purpose. As the PS, LDPE can be enlisted, and CPP or the like can be enlisted as PP. Further a material which can easily be adhered thermally or can easily be separated may be added in the polyolefin-based rein or PS described above. As the additives, for instance, there can be enlisted such materials as EVA (ethylene vinyl acetate), polyolefin-based resins with such as rubber as SBS (styrene-butadiene-styrene) rubber or EPR (ethylene-propylene rubber) kneaded therein, a mixture of PP (polypropylene) and PE (polyethylene) or the like.

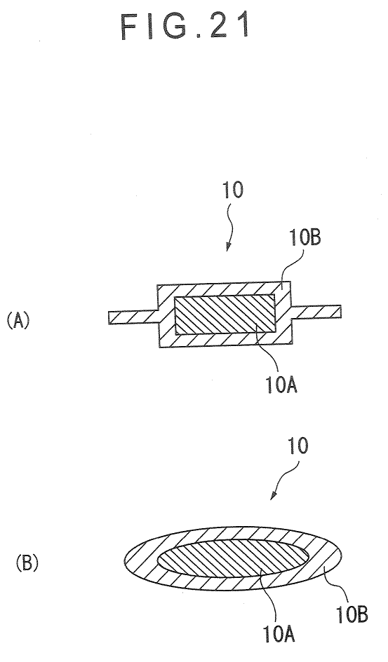

A cross section of the atmosphere improving tape 10A has any form on the condition that the atmosphere improving layer 10A has a cross section coated with the thermoplastic resin layer 10B, and for instance, as shown in FIG. 13, the rectangular atmosphere improving layer 10A is completely covered with the thermoplastic resin layer 10B in the embodiments described above, but the present invention is not limited to this configuration, and various configurations are allowable including that in which the rectangular atmosphere improving tape 10A is covered with the thermoplastic resin layer 10B as shown in FIG. 21(A) and protrudes from a side face of this thermoplastic resin layer 10B, or that in which an area around the circular atmosphere improving layer is covered with a doughnut-shaped thermoplastic resin layer 10B as shown in FIG. 21(B).

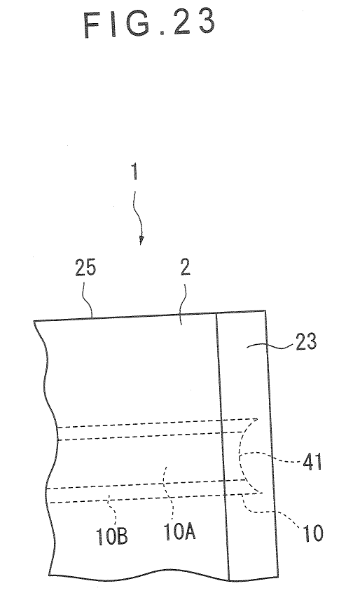

Further, in the embodiments described above, the atmosphere improving layer 10A in an edge section of the atmosphere improving tape 10 has a semicircular notched from as shown in FIG. 12, but this invention is not limited to this configuration, and various forms of the edge section are allowable including that in which the edge section of the atmosphere improving tape 10 has a linear form, and that in which the notched section 41 is formed in the edge section of the atmosphere improving tape 10 and the notched section 41 has a semicircular form as shown in FIG. 23.

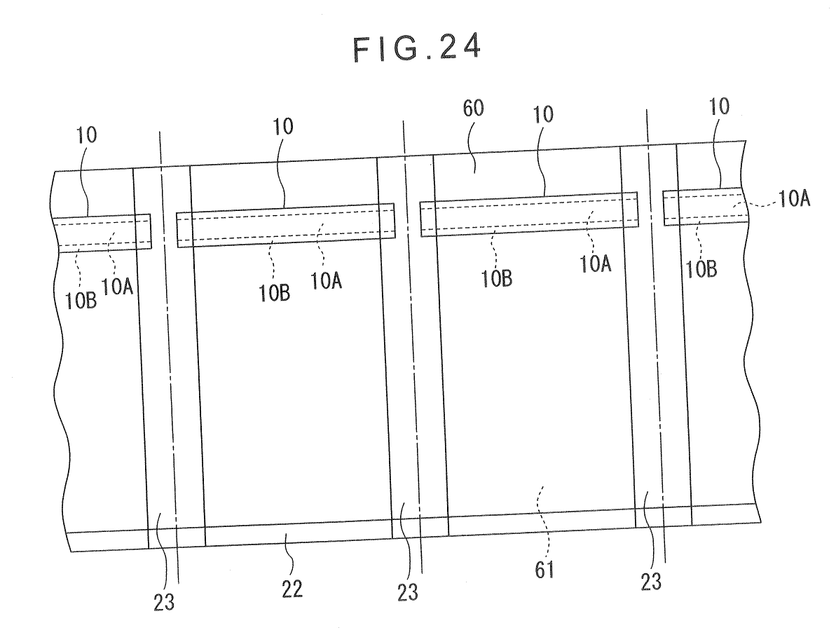

In the embodiments described above, the package 1 with an atmosphere improving tape is manufactured by continuously feeding out the atmosphere improving tape 10 and thermally adhering the atmosphere improving tape 10 on the sheet 61 as shown in FIG. 14 to FIG. 20, but the present invention is not limited to this configuration, and for instance, the package 1 with an atmosphere improving tape may be manufactured by thermally adhering a plurality of cut pieces of the atmosphere improving tape 10 each piece having a prespecified length to the sheet 61 and overlaying the sheet 60 thereon from the top side as shown in FIG. 24. Also in this case, in an edge section of the atmosphere improving tape 10 in its extending direction, the atmosphere improving layer 10A is buried in the side heat-sealed section 23.

Other structures and configurations may be employed for carrying out the present invention on the condition that the objects of the present invention can be achieved.

The present invention is described in more details with reference to the examples and comparative examples. It is to be noted that the present invention is not limited to contents of the examples.

### EXAMPLE 14

The present invention is more specifically described below with reference to an example thereof and comparative examples.

In the embodiments described above, the atmosphere improving tape 10 and the package 1 with an atmosphere improving tape are manufactured under the following conditions.

The atmosphere improving layer 10A of the atmosphere improving tape 10 was prepared by extruding a master batch prepared by kneading polystyrene (Idemitsu Styrole ET63 produced by Idemitsu Petrochemical Co., Ltd.) and an iron-powder oxygen absorbing agent (comprising iron powder with the bulk specific weight of 2.0 and the specific surface area of 0.5 and salt or the like) at the weight ratio of 40:60 to form pellets of the mixture.

LLDPE (Moretech 0238CN produced by Idemitsu Petrochemical Co., Ltd.) was used as a material for the thermoplastic resin layer 10B.

### COMPARATIVE EXAMPLE 14

In Comparative Example 14, the package 1 with an atmosphere improving tape was manufacture under the same conditions as those employed in Example 14 except that punching with the punching device 40 was not carried out to the atmosphere improving tape 10. Namely, in the package 1 with an atmosphere improving tape manufactured in Comparative Example 14, in the edge section of the atmosphere improving tape 10 in its extending direction, the atmosphere improving layer 10A is buried in the side heat-sealed section 23 and is not thermally adhered thereto, and the edge section of the atmosphere improving tape 10 is exposed to outside of the package 1 with an atmosphere improving tape.

As the edge section of the atmosphere improving tape 10 is exposed to outside of the package, when the portion is kneaded with hands, the atmosphere improving layer 10A and the thermoplastic resin layer 10B were separated from each other.

### COMPARATIVE EXAMPLE 15

This comparative example is different from Comparative Example 14 in the point that the atmosphere improving tape 10 is not used. Further the sheets each constituting the package are different, and the sheet used in Comparative Example 15 has a three-layered laminated structure comprising an outer layer, an inner layer, and an outer layer.

This sheet was molded with a multilayered extrusion device having two units of extruders each with the screw diameter of 30 mmΦ. Resin for the top and bottom outer layers was extruded with one of the extruder, and resin for the inner layer was extruded by another extruder. LLDPE (More tech 0238 CN produced by Idemitsu Sekiyu Kagaku K. K.) was used as the resin for the outer layers. The resin for the inner layer was prepared by extruding a master batch prepared by kneading polystyrene (Idemitsu Styrole ET63 produced by Idemitsu Petrochemical Co., Ltd.) and an iron-powder oxygen absorbing agent (comprising iron powder with the bulk specific weight of 2.0 or more and the specific surface area of 0.5 or more and salt or the like) at the weight ratio of 40:60 to form pellets of the mixture. The adhesion strength between the inner layer and outer layers in this sheet was 500 g/15 mm in width.

### Testing for Evaluation

100 ml of water and 2 ml of air were filled in each of the packaging bodies obtained in Example 4 and Comparative Examples 4 and 15 from the opening section, and the opening section was thermally adhered with the width of 10 mm for tight-sealing the package.

The tight-sealed package was heated by boiling it for 40 minutes at 115° C., and then the state of the package was checked.

In Example 14, leakage of iron powder and PS from the atmosphere improving layer did not occur, and therefore it was determined that the product could be applied to practical use. In Comparative Example 14, the edge section of the tape is the same as that of the package, and because of this feature, it was determined that PS leaked from an edge section of the tape and the product could not be used for actual purposes. In Comparative Example 15 layers of the sheet constituting the package were separated from each other, and it was determined that the product could not be used for practical purposes.

### INDUSTRIAL AVAILABILITY

The present invention relates to an atmosphere improving tape for a package, a package with the atmosphere improving tape, a packaging container with the atmosphere improving tape, a zipper, and a packaging container with the zipper, which can be used for packaging foods, medical drugs, clothes, machine parts and the like,

1-12. (canceled)

13. A zipper comprising a male member and a female member engaging each other, wherein said male member and female member each has a belt-formed base section and an engagement section having an engaging function; and
wherein an atmosphere improving layer containing an atmosphere improving material is provided in said belt-formed base section and/or in said engagement section.

14. The zipper according to claim 13, wherein said atmosphere improving layer is made from a material prepared by kneading an atmosphere improving material and a thermoplastic resin.

15. The zipper according to claim 13 or claim 14, wherein said atmosphere improving material contains at least one of a water absorbing material, a drying agent, a volatile antibiotic agent, a volatile preservative against mold, a volatile antitick agent, a volatile insect repellent, a deodorant, a volatile antirust agent, a volatile animal repelling agent, a deoxidizing agent, and an absorbent.

16. A package with a zipper having a sheet fused to a periphery thereof for blocking exposure of the contents to air, wherein the zipper according to any of claims 13 to 15 is thermally fused to an internal surface of said sheet.

17-21. (canceled)
